(19) United States
(12) Patent Application Publication
(10) Pub. No.: US 2019/0270118 A1
(43) Pub. Date: Sep. 5, 2019

(54) CYBER-PHYSICAL SYSTEM AND VIBRATORY MEDIUM FOR SIGNAL AND SOUND FIELD PROCESSING AND DESIGN USING DYNAMICAL SURFACES

(71) Applicant: Jake Araujo-Simon, Brooklyn, NY (US)

(72) Inventor: Jake Araujo-Simon, Brooklyn, NY (US)

(21) Appl. No.: 16/290,461

(22) Filed: Mar. 1, 2019

Related U.S. Application Data
(60) Provisional application No. 62/637,089, filed on Mar. 1, 2018.
(60) Provisional application No. 62/795,841, filed on Jan. 23, 2019.

(51) Int. Cl. B06B 1/02; G06N 7/00

(52) U.S. Cl. CPC B06B 1/0215; G06N 7/00

(57) ABSTRACT

Embodiments described herein include a vibratory system implemented by mathematical modeling of one or more surfaces using computer software and hardware, such as pressure-sensitive screens and pads, to model perturbations to the surface by one or more entitles. The one or more entities may be logically linked, or coupled, with models of dynamical surfaces. The entities may input to the surfaces, synthesize signals on the surfaces, sample outputs from the surfaces, and analyze signals from the surfaces.

### CROSS REFERENCE TO RELATED APPLICATIONS

This application claims benefit of U.S. Provisional Application No. 62/637,089 filed on Mar. 1, 2018, and U.S. Provisional Application No. 62/795,841 filed on Jan. 23, 2019, the contents of which are incorporated herein.

### BACKGROUND

Sound fields experienced in the real world may be dynamic, distributed, and interconnected. In contrast, the sounds of typical musical media, events, performances, and environments may be spatially centralized and functionally disconnected from their surroundings. For instance, sounds in a typical concert emanate from specific sources, such as instruments or speakers, with relatively static positions. The sounds then propagate in effectively closed acoustic systems, such as a hall or room, which are functionally disconnected from the sounds of neighboring space.

In a cyber or digital domain, music services, such as services for streaming or sharing music, typically provide asynchronous and fragmented user experiences. The experiences of different users interacting with the service in different places are not causally related in a coherent and cohesive functional model. The experiences of different users, streaming or listening in different places, may be functionally disconnected.

### SUMMARY

Embodiments described herein include a vibratory system implemented by mathematical modeling of one or more surfaces using computer software and hardware. A method for use in a computational platform (CP) for the distribution of sound in a cyber-physical system may include receiving one or more inputs from one or more sensors receiving a first sound in a first physical space. A mesh of a first oscillating manifold (OM) modeling the first physical space may be constructed comprising one or more points corresponding to the one or more sensors. The one or more inputs may be parameterized over the mesh to form a rain comprising a sequence of regular pulse fields. The rain may be imparted on a second OM modeling an open dynamical surface (ODS), such that one or more waves propagate on the second OM and are sampled by a second CP in order to generate a second sound in a second physical space using one or more actuators.

A CP for the distribution of sound in a cyber-physical system may include a processor operatively coupled to one or more sensors receiving a first sound in a first physical space. The processor may be configured to receive one or more inputs from the one or more sensors. The processor may be further configured to construct a mesh of a first OM modeling the first physical space comprising one or more points corresponding to the one or more sensors. The processor may be further configured to parameterize the one or more inputs over the mesh to form a rain comprising a sequence of regular pulse fields. The processor may be further configured to impart the rain on a second OM, such that one or more waves propagate on the second OM and are sampled by as second CP in order to generate a second sound in a second physical space using one or more actuators.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a diagram illustrating an oscillating manifold (OM);

FIG. 2 is a diagram illustrating rain on an OM;

FIG. 3 is a diagram illustrating a system of coupled oscillating manifolds (COMs) with a cascade structure;

FIG. 4 is a diagram illustrating a system of coupled OMs (COMs) with a patchwork structure;

FIG. 5 a flowchart illustrating the steps for forming and evolving a patchwork OM (i.e., system of COMs);

FIG. 6 is component diagram of a computing device that may be used as a computational platform (CP);

FIG. 7 is a component diagram of a server that may be used as a CP;

FIG. 8 is a diagram illustrating a cyber-physical system;

FIG. 9 is a flowchart illustrating a synchronous distributed localization of sound in a cyber-physical system; and

FIG. 10 is a high-level flow chart illustrating the synchronous distributed localization of sound in a cyber-physical system.

### DETAILED DESCRIPTION

In the following description, numerous specific details are set forth, such as particular structures, components, materials, dimensions, processing steps, and techniques, in order to provide a thorough understanding of the embodiments. However, it will be appreciated by one of ordinary skill of the art that embodiments may be practiced without these specific details. In other instances, well-known structures or processing steps have not been described in detail in order to avoid obscuring aspects of the embodiments.

Further, in the interest of not obscuring the presentation of embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments described herein.

Methods, systems, and apparatuses that simulate interaction between dynamical surfaces and individual entities or an entity network are described herein. The entities may be logically linked, or coupled, with models of dynamical surfaces. The entities may input to the surfaces, synthesize signals on the surfaces, sample outputs from the surfaces, and analyze signals from the surfaces. These actions may involve changing sound field data that may exist on the surfaces. The surfaces themselves may be queried and constructed, interconnected, disassembled, arranged, configured, and edited. A cyber-physical system may support operation on the sound field data and operation on the sound field structure itself.

The following description may be applied to acoustic connections of spaces, device-to-device communications, real-time musical collaboration, interaction and performance over scalable networks, virtual and/or augmented reality, social networking, gaming environments, and the like.

As a result of the disparate nature of cyber acoustic environments, and between the sound fields therein, dynamic interaction and communication between entities in these environments via the media of sound, as well as large scale social or musical applications have not been fully realized. Unlike environments that humans experience in the physical world, where sound propagates through synchronous and reactive compositions of coupled acoustic media, typical cyber systems may have no acoustic media through which sound can propagate, or for live sound to exist at all.

For example, what is typically referred to as digital audio may be devoid of the semantics of sound. Adjacent transmissions of pulse code modulation, the canonical time-domain format of digital audio, may be non-interacting. The signals may be partitioned and discretized in static media in ways that do not preserve intrinsic sonic semantics during propagation. Digital audio, as it is stored and processed in typical cyber systems, may not be live sound as it may be stored in a binary code of 1s and 0s. The audio may be made live through conversion to analog and transduction into a physical acoustic medium. Digital audio that is not alive (i.e., propagating in an acoustic medium) may be dead with respect to that medium. A dead sound may lack potential for propagation, or continuation in an acoustic medium. In other words, digital audio, as stored within a memory, encoding, and/or propagation medium where it is established or being transmitted, may not be a real or coherent acoustic wave.

An example of a conventional system for transmission of digital audio may be a system for telecommunications, in which channels of communication may be established between one or many entities in a communications network. Digital audio may be encoded in a standard format, such as a signal of pulse code events or as pulse code modulation (PCM), and may be transmitted between the entities. However, from the moment that a signal produced by an entity at one end of a call is encoded into digital form until the moment when it is decoded to analog by a digital actuator and transduced back into air, the signal may be dead with respect to the medium through which it is transmitted. The system may not allow entities to synchronously participate in live processing and communication of a joint stream of the digital audio. In addition, the signal may be partitioned and distributed during routing across multiple static binary files. The arrangement and orchestration during transmission may not support coherence of the signal except at the communication endpoints.

Another example of a conventional system for transmission of digital audio may be a gaming environment, such as virtual or augmented reality. Computation, transmission, and/or reconstruction of digital audio may not occur unless triggered by an event semantically orthogonal to the digital audio itself (i.e., an event the digital audio does not affect or determine). Upon being triggered, the dead and preprogrammed digital audio may be actuated, usually via a speaker, into air to become a live sound. In contrast, sounds propagating in physical acoustic media may vibrationally and mechanically interact with their surroundings during continuous evolution of the media. Typical virtual or augmented reality systems may present the appearance of live sounds propagating within the environments, but may only implement non-deterministic and/or asynchronous reconstruction of individual sounds triggered by semantically orthogonal events.

Even conventional systems for processing sounds, such as a digital audio workstation (DAW), may not provide support for processing of live digital audio propagating in a synchronous and reactive, compositional acoustic medium. Rather, digital audio in the DAW may be encoded in static binary files and may be processed only when queried or triggered by events that may be asynchronous and/or semantically orthogonal to the sound itself. In addition, the DAW may not enable synchronous localization of live sound over a distributed computer communications processor network.

Conventional modular systems that provide basic building blocks for design of programs and can be used to simulate other systems, such as systems based on data flow models of computation, may enable simulation of acoustic media within which live sound may propagate. However, the conventional modular systems may be limited, which may impede utilization in certain applications and their integration or extension into more general systems. For example, there may be no effective methods using the systems to enable scalable synchronous composition of the media with other acoustic media, including physical acoustic media of the real world. In addition, the systems may be limited in their strategies for modeling of the acoustic media and, for example, may be unable to simulate or implement acoustic media of variegated, exotic, flexible, adaptable, and/or dynamic shape and geometry.

Conventional systems for processing sound may not provide the properties necessary for incorporating the semantics of live sound, such as synchrony and reactivity. For example, these systems may utilize methods based on closed-form analytic solutions that rely upon extensive prior knowledge of the acoustic computational domain, including its parameterization and boundary conditions, and upon its conformity to a corresponding domain for which solutions to the relevant acoustic wave equations are known. The methods may be inflexible and may not adapt to qualitative changes in the acoustic computational domain. These systems may not be well-suited for enablement of general processing of sound in scalable compositional acoustic media.

Accordingly, it may be desirable to provide a system for the processing of live sound propagating in a compositional and reactive cyber-physical acoustic medium that may be controlled and shaped at a higher level than conventional systems. As described below, this may be accomplished by modeling the numerical evolution of one or many coupled dynamical surfaces, which may be referred to as oscillating manifolds (OMs) that may be driven locally and automatically by a Laplace operator. A perturbative model may be used for modulation of the manifold vibrations. This may be based on a general input signal format, which may be referred to below as a rain.

The following definitions may be used throughout the description below. A dynamical surface may be an acoustic medium. A dynamical surface may be of any dimension (i.e., a hypersurface), and may be formally defined as a manifold of dimension n−1, which is embedded in an ambient space of dimension n. The methods presented below generalize from 2 dimensional surfaces to 3 dimensional surfaces. A dynamical surface may be a surface in the world that is vibrating. Thus, an elastic string, a film of water, and a volume of air may be dynamical surfaces that may be modeled by manifold simplicial complexes of dimension 1, 2, and 3 respectively.

An OM may be a model of a dynamical surface. For example, whereas a physical water surface may evolve continuously in the physical world with atomic resolution, a model of the water surface may be simulated using a triangulated 2-manifold evolving by the Laplacian. The properties of water may be approximated as an ideal fluid by using an adaptive finite element method (AFEM), such that the model may flexibly adapt and the simulation may stay well-conditioned. Fluidity as a property of the simulation may be obtained as a limit of computational resources.

An open dynamical surface (ODS) may be a dynamical surface that is interacting with its environment. A solitary OM may be defined that evolves in isolation, which maybe a linear and time invariant system. For example, a soap bubble oscillating in zero gravity on a space station might be approximated by a solitary spherical OM. In practice, applications may involve systems of coupled OMs (COMs) modeling interconnections of ODSs. For some applications, it may be useful for users to simulate OMs that can vary between being open and closed. For example, a musician may generate a landscape of sound on a spherical OM by adding sources of sound (rains). During a generation process, the OM may correspond to an ODS, but after introducing the desired sounds, the OM may be turned into a solitary OM modeling a closed ODS and the OM may be allowed to resonate. The OM may then be coupled at a later time, and the resonance it undergoes in isolation may produce a musically interesting result. However, over the full range of time considered, the dynamical surface modeled by the OM may still be considered open, even if locally over certain intervals it is closed.

A system of COMs may be multiple OMs that are connected such that sound may flow between them. Thus, a system of COMs may be OMs that are connected via one or more of a patchwork composition and a cascade composition, either directly or indirectly by other intervening OMs. For example, sound fields in two rooms may be modeled by independent OMs, each OM having the shape of the room it is modeling. Sections where one room is connected to another room may be modeled by compositions of the OMs. If there are two chambers, each in the shape of a sphere with a disc cut out, that are connected by a hallway between the two disc-shaped holes, then the interconnected sound field of the entire space may be modeled by two spherical OMs, each coupled at the rim of the disc-shaped hole to one end of a cylindrical OM.

A sound field domain may be a section of a dynamical surface that is modeled by a simplicial submanifold of an OM modeling the dynamical surface. A sound field domain may be what is modeled by the structure over which the sound field data of an OM exists. As such, sound field domains may be modeled by manifold meshes, or simplicial manifolds. The mesh of an OM modeling an entire dynamical surface may be a sound field domain, as is the mesh comprised of a single point on a larger dynamical surface. A sound field domain may represent sites of input and output (i.e., ingress and egress of sound).

A sound field domain may provide the semantic context for interpreting the construction of a composition and transfer of sound between COMs. The submanifold meshes that specify where, on their respective surfaces, the component OMs are being connected, may represent the sites of contact between physical acoustic media that are coupled and coevolving.

A model of a sound field domain (i.e., a mesh) may be converted to an OM by applying the cyclic evolution process that drives OMs. Thus, given, for example, an array of sensors arranged in some shape, the mesh representing the shape of the arrangement of sensors may provide a concrete interface over which to establish contact between one acoustic medium (e.g., ODS) and another.

The cyber-physical acoustic medium described below may be a temporally integrated distributed embedded system that uses mathematical modelling for sound wave propagation in a synchronous and reactive composition of coupled OMs. Operating independently, the system may enable multiple new categories of experience for individual and networks of entities, such as human musicians. The cyber-physical acoustic medium may provide a new paradigmatic interface and environment for musical instrumentation and composition of sound, including the synthesis and analysis of spatially distributed live sound fields. Operating in conjunction with other systems, such as other systems for social networking, gaming, or communication, the system may act as an integrable, cyber-physical acoustic substrate for realization of live sound propagation. The system may integrate computational and physical systems, and may serve as an interface between various cyber and physical processes. By enabling this interface to vibrate, store and transmit information, and propagate acoustic energy, the system may join the worlds of cyber and physical sound and produce a unified flow of sounds.

As discussed in further detail below, a medium may be a field that is evolving by a wave equation. A field may be a quantity defined at each point in a space. A transmission medium may be a medium in which waves propagate. An acoustic medium may be a medium in which the propagation of waves may be described by an acoustic wave equation. A wave propagating in an acoustic medium may be a sound.

A space may be modeled by a manifold simplicial complex or simplicial manifold. A function, or scalar field, may be parameterized over the manifold and may be said to be on the manifold. The function on the manifold may model a potential (e.g., pressure, temperature, tension, or charge) of the field in a space modeled by the manifold. The field in the space, or function on the manifold, may evolve in time as described by an acoustic wave equation. Simplicial methods may enable design and redesign of ODS meshes.

A dynamical surface may generally be defined as open in the sense of an open dynamical system, and may be referred to as an open dynamical surface (ODS). A dynamical surface evolving in isolation may be referred to as a closed dynamical surface. Ports for a solitary OM may be taken as the empty set. An ODS may be the compositional unit of the vibratory medium, and may be composed of smaller ODSs composed in series or in parallel. The smaller ODSs may be composed of yet smaller ODSs at a lower level, and the entire composition may have a nested structure. ODSs considered as networks may be recursively built up from smaller networks, and the process of assembly may continue perpetually. Certain ODSs in a nested system may be identified as atomic, or prime, and may exist at the lowest level of a hierarchy of nested ODS.

Cascade compositions of ODSs considered as systems may correspond to a series composition of the systems and may carry a natural temporal ordering. Side-by-side composition of ODSs considered as systems may correspond to joint (i.e., state sharing) or disjoint parallel compositions of the systems. Patchwork compositions of ODSs may be a type of composition where a specified boundary state and a specified interior state of the ODSs may be shared and identified as overlapping, but the inputs and outputs of the ODSs may otherwise be disjoint. Properties such as determinism may be compositional properties of ODSs under these types of composition.

An ODS may have a variety of communicative modes, which may determine the inputs and outputs of the ODS. The ODS may repeatedly update its communication mode. For example, an ODS implementing a quiescent OM may have only an input port for listening. In another example, an ODS may implement an OM that has only output ports. In yet another example, an ODS implementing an OM that is receiving input from other OMs may be identified as waiting to execute evolution of a Laplacian. A set of ODSs may be arranged into an aggregate, which may be a higher-level ODS having its own set of communicative modes that may determine its input and output ports and the way it may connect with other ODSs in its environment. This may be implemented using operads and may be known in the art of nesting of dynamical systems and mode-dependent networks.

Information may flow through an ODS considered as a network Y according to a wiring diagram in the operad of mode-dependent networks as follows. Each inner ODS that makes up the network Y may convert its state to an output. The outputs of these inner ODSs, together with the input to the network Y, may be carried through the wires and either exported from Y or fed as inputs to the inner ODSs. The inner ODSs then may use the input to update one or more of their state, their communication mode, their own shape, and the shape of the entire ODS system, Y.

Dynamic flows of information in a network of processes may be formalized using an operad W and a W-algebra of processes, which may be referred to as propagators. An object X in W may have a finite set of input wires, a finite set of output wires, and a function called the value assignment for X which may assign to each input or output wire the set of values it may carry. Morphisms in W may be directed wiring diagrams in which wires may split but not merge, as merging may occur within a particular object. Feedback loops may be allowed. Control and mechanism arrows may be subsumed into input and output arrows, and rules and meaning of a hierarchical composition may be made explicit. The operad and its algebra may be useful as a graphical language for modeling time-based processes, known in the art of temporal wiring diagrams, and may be used to model dynamic flows of information in a network of ODSs. The model may capture a hierarchical and self-similar aspect of network of ODSs. The ODSs may be considered propagators and may be arranged into a system that is itself a propagator at a higher level.

Communication between ODSs may take time, which may be modeled by giving communication channels in the network a length. In particular, in a communication between ODSs where a rain is transmitted and received, the model may capture the length of the communication by using a natural generalization of the notion of an n-historical stream propagator to the case where the domain and codomain of what is communicated may have spatial extent over a parameterization by the transmitting and/or the receiving propagators. Thus, ODSs in a network may be considered as n-historical rain propagators.

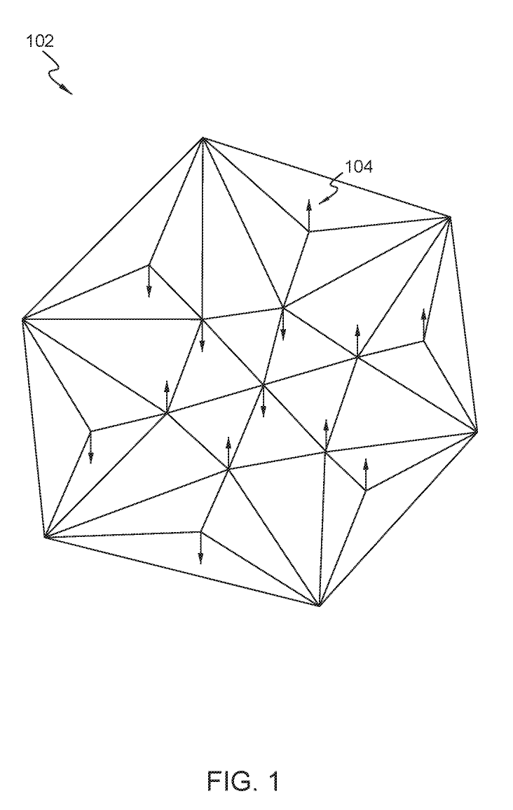

Referring now to FIG. 1, a diagram illustrating a snapshot of an OM 102 in time is shown. An OM 102 may be manifold that is parameterizing a function that is evolving over its surface as a result of the wave equation. In other words, an OM 102 may refer to both the manifold and the function acting together. The function on the OM 102 may be referred to as the sound field potential of the OM 102. At each step in its evolution, the sound field potential of the OM 102 may represent its velocity, or the instantaneous deformation of its surface in the normal direction. Waves propagating in the sound field potential as it evolves in time over the OM 102 may be referred to as vibrations of the OM 102. The vibrations of an OM 102 may model sound in an acoustic medium.

An OM 102 may be modeled as an actor with input ports and output ports. The OM 102 may execute at ticks of a global clock. At each tick of the clock, execution of the OM 102 may implement a firing function that maps input signals to output signals. The firing function at each tick may be defined by a transition function, derived from a wave equation that describes evolution of the OM 102 sound field potential. The execution at each tick may be treated as instantaneous, and the input signals as simultaneous with the output signals.

The evolution of a solitary OM 102 may be described by a homogeneous wave equation. The heart of the equation may be a Laplace operator defined over the simplicial parameterization of the OM 102 sound field potential. The sound field potential of the OM 102 evolving, as described by the wave equation, may be constrained by certain conditions to take on specified values, rates of change, and/or mixtures thereof. The constraints may include one or more Dirichlet boundary conditions, Neumann boundary conditions, and absorbing or transparent boundary conditions at the boundary of the surface of an OM 102 with a defined boundary. In an actor model of the OM 102, signal output by the actor may flow to the actor as input. The firing function, defined by the transition function derived from the homogeneous wave equation, may operate on the sound field potential by the Laplacian. The firing function may return a new sound field potential that may flow as signal output from the actor. The evolution of the actor model of an OM 102 may be generated by its execution in a closed feedback-control loop. A solitary OM 102 may be a linear and time invariant system.

Sound may propagate from one acoustic medium to another along, across, or through an interface of the media. A pair of acoustic media that are interacting via the flow of sound from one to the other across an interface may be modeled by a synchronous cascade composition of two OMs 102. In this case, a signal may be output from, or emitted by, one medium and input to, or absorbed by, the other medium. The evolution of an OM that absorbs a signal emitted by another OM 102 may be described by an inhomogeneous wave equation. The wave equation may be composed of a homogeneous term expressing the steady state, or normal vibration of the OM 102, and a forcing term expressing modulation of the vibration by a perturbation decoded from the input signal.

A perturbation absorbed by an OM 102 may be represented by a source of waves in its sound field potential. The source may be periodic, or defined for all time. The source may also be transient, or defined for a finite timespan. A periodic source may be one or many superposed sinusoidal waves, and a transient source may be a pulse, or piece-wise defined waveform or wavelet with compact support, such as a sinusoidal or Gaussian wave filtered by a rectangular window. The source may be localized in space and time on the OM 102. The source may be a pulse that is instantaneous and spatially periodic over the OM 102; such a source may be purely localized in time unto a fundamental rate of the OM 102 evolution. The source may be a periodic wave at a point on the OM 102; such a source may be purely localized in space unto a fundamental scale of the OM 102 simplicial discretization. A source of OM 102 sound field potential may be defined over an entire OM 102 for all time, at a point on an OM 102 for an instant, and anywhere on the spectrum defined between these poles.

Modulation of the vibration of an OM 102 by an instantaneous pulse applied to a point on its surface may be realized by addition of a scalar value, representing the pulse amplitude, to the sound field potential at the point. Addition of the scalar value may represent absorption of the pulse by the OM 102. Absorption of the pulse may cause waves to propagate as ripples outwards from the impulse cite as the OM 102 evolves. The scalar value representing the pulse amplitude may be quantized in a range of discrete steps, or bits, referred to as the bit depth of the modulation. The potential at the point where the pulse is absorbed may also be quantized in a range of discrete steps, representing a range of admissible values for the potential at the point.

FIG. 1 shows arrows 104 extending from the OM 102 in a direction normal to a vertex from which it emanates. The length and sign of an arrow 104 may represent a scalar value. At vertices where no arrow 104 is pictured, there may still be an arrow 104, but it may have zero length, indicating that the surface of the OM 102 is not moving in the normal direction.

In other words, the arrows 104 may show vertex velocities. The arrows 104 may be related to the scalar numbers, which are not shown but may be implicit and represent the vertex potentials, by the normal vector construction, which associates to each vertex of the surface a vector of unit length that points in the positive direction perpendicular to the surface at the vertex, and represents the direction that the surface is moving in there, but does not carry magnitude information. The scalar number, or height associated to each vertex (i.e., the sound field potential at the vertex) represents the magnitude with which the surface moves in the normal direction locally at the vertex.

The amplitude of the sound field potential at each point on an OM 102 may be limited to a range of values, of which the upper and lower limits may represent limits of possible displacement in the positive and negative directions of the OM 102 surface at the point. If perturbation of an OM 102 by pulse modulation of the sound field potential at a point on its surface would cause the value of the potential at the point to exceed the upper or lower limit of admissible displacement at that point, the potential may be truncated or clipped, and set as the would-be exceeded limit. Alternatively, the scalar value representing the pulse amplitude may be transformed before addition to the OM 102 potential at the point by use of a generalized Lorentz transformation. This may treat the pulse amplitude purely in relation to the intervallic distance between the amplitude of the sound field potential at the point and the limit of possible displacement there, such that absorption of the pulse may impart a so-called Lorentz boost to the OM 102 locally at the point.

An OM 102 may also be perturbed by a stream of pulses at a point on its surface as it evolves over time. Modulation of the vibration of the OM 102 by absorption of individual pulses in a stream may be realized as described above. Absorption of subsequent pulses in a stream of pulses may occur at regularly spaced intervals of time. An evolution step of the OM 102 may define the fundamental unit of temporal progression. The number of evolution steps occurring between absorption of subsequent pulses may be an integer value representing the modulation rate. The stream of pulse modulation with a well-defined bit depth and sample rate may be represented using the canonical time-domain format of digital audio known as pulse code modulation (PCM). A stream of PCM may be imparted to an OM 102 at a sequence of points on its surface, over an interval of time quantized by its discrete evolution. In this way, a stream of PCM may be used to modulate the vibration of an OM 102.

The vibration of an OM 102 may also be modulated by absorption of an instantaneous pulse that is spatially extended over a submanifold section of the surface of the OM 102. The submanifold section may contain points and connected components such as strings, patches, or sheets of the surface. The pulse may be defined by a scalar field parameterized over the simplicial submanifold section. The value of the field at each point on the submanifold may represent the amplitude of the pulse at the point. A pulse of this type may be called a pulse field. The pulse field may be a general type of pulse. The pulse field may include a familiar type of pulse represented using a single scalar value. A pulse represented by a single scalar value may be a pulse field defined over a point or connected zero-dimensional simplicial manifold.

In order for an OM 102 to be effectively perturbed by absorption of a pulse field, the pulse field may be aligned with a submanifold section of the surface of the OM 102. A map may be constructed from the simplicial surface parameterizing the pulse field to a submanifold section of the simplicial surface of the OM 102. The function on the simplicial surface, representing the pulse field amplitude, and the function on the submanifold section, representing the sound field potential, may be combined in a way that preserves structure of the functions. Various mappings may be used to align the manifolds. The mappings may have different numerical properties.

To preserve structure of the functions, a structure-preserving mapping may be used for the alignment. Structure-preserving maps may preserve intrinsic sonic semantics when composing sound fields. A harmonic map of a function on a simplicial surface may minimize the function energy over the surface. A conformal map of the function may minimize both the function energy and the angle distortion of its simplicial parameterization. Particular methods for harmonic and conformal mapping of functions on simplicial surface are described in further detail below.

A pulse field whose surface is aligned with the surface of an OM 102 may be imparted to the OM 102 by combination of the pulse field amplitude with the OM 102 sound field potential over a set of points where the surfaces are aligned. This may be done using the method described above for modulation of the OM 102 sound field potential at a point. In this way, a pulse field absorbed by an OM 102 may modulate its vibration.

A signal input to an OM 102 or output from the OM 102 may be extended in time. A sequence of pulses, with a well-defined bit depth and sample rate that measures the time-varying amplitude of a quantity at a point, may be referred to as a rain. The rain may be represented using a traditional signal format such as PCM. A sequence of pulse fields may be represented using a format known as pulse field modulation (PFM).

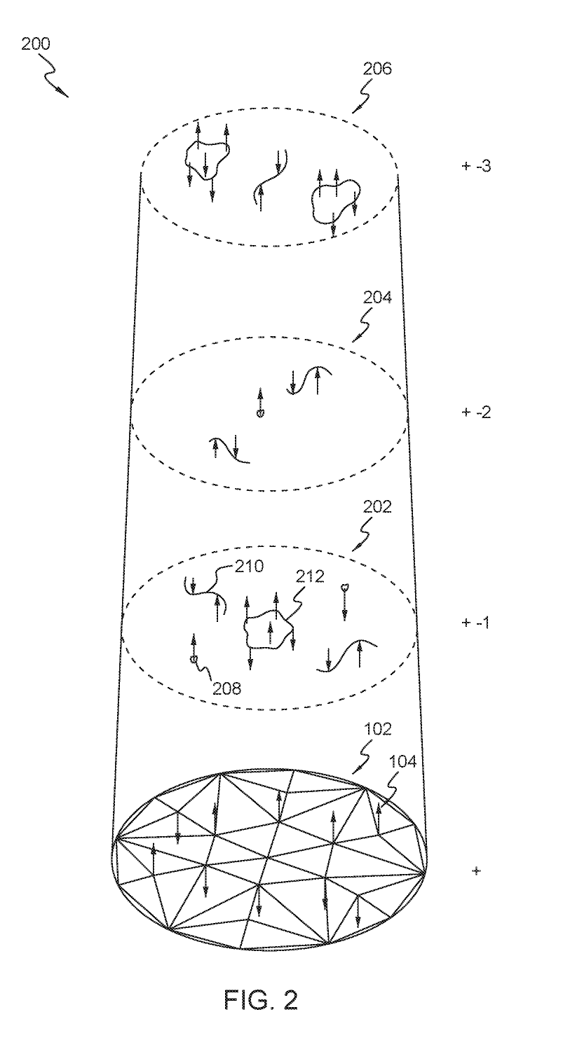

Referring now to FIG. 2, a diagram illustrating rain on an OM 102 is shown. A rain may be a sequence of pulse fields emitted or absorbed in a tubular neighborhood of an ambient space of an OM 102. A rain may be formed by sampling the sound field potential of an OM 102 over submanifold sections of its surface as it evolves. The submanifold sections may be covered by a domain on the surface, for example, by a union of the convex hulls of the components. The rain may then lie in the tubular neighborhood of the ambient space of the OM 102 containing the space swept out by the surface domain as the OM 102 evolves. In the simplest case, a rain may consist of an instantaneous emission or absorption of a pulse at a point on an OM 102. This may be visualized as a drop falling from or onto the OM 102. In general, a rain may be composed of one or more of individual drops, streams of drops, streams of curves and sheets of rain, and tubular neighborhoods of sequences of pulse fields containing these elements.

FIG. 2 shows an example of a rain 200 being emitted from the OM 102. The variable t may represent time. The OM 102 is shown as triangulated at time t. A first pulse field 202 shows a first regular cross section of the rain 200 sampled at t−1. A second pulse field 204 shows a second regular cross section of the rain 200 sampled at t−2. A third pulse field 206 shows a third regular cross section of the rain 200 sampled at t−3. The first pulse field 202, the second pulse field 204, and the third pulse field 206 may be individual uniformized pulse fields which are snapshots of the domain over which the rain 200 of pulse field modulation is sampled.

As described above, the OM 102 at time t is shown with arrows 104 representing the surface velocity vector field. Arrows 104 are also shown emanating from dots 208, curves 210, and sheets 212 in the first pulse field 202, the second pulse field 204, and the third pulse field 206. The dots 208, curves 210, and sheets 212 may be pulses, each representing a local quantum of displacement which, when absorbed, may impart that displacement to the absorbing surface. A dot 208 has a single arrow 104, a curve 210 has at least two arrows 104, and a sheet 212 has more than two arrows 104. Although not shown, there may be a triangulation underlying each of the first pulse field 202, the second pulse field 204, and the third pulse field 206, which may be part of the information encoded by the rain 200. A difference between an OM 102 and a rain 200 may be that an OM 102 is an object which evolves in time based on its state and its inputs, whereas a rain 200 is a signal that encodes a measurement, history, or observation of the evolution of an OM 102.

A rain 200 may be formed in the ambient space of an OM 102 by sampling of the sound field potential over a domain on its evolving surface. The sequence of pulse fields composing the rain 200 may propagate normally outwards from the OM 102 at a rate proportional to the fundamental rate of the OM 102 evolution. During the process of formation of a rain 200, the domain over which each pulse field is obtained by sampling of the sound field potential may be conformally or harmonically mapped to a canonical domain. For example, if the domain over which the pulse fields of a rain 200 are sampled has disk topology, then each pulse field obtained may be taken to the canonical flat disk via a conformal map. Similarly, if the domain has spherical topology, then each pulse field sampled may be taken to the canonical sphere. In this way, the sequence of pulse fields sampled over submanifold sections of the surface domain and harmonically or conformally mapped may form a sequence of regular cross sections of a tubular neighborhood in the ambient space of the OM 102 as it evolves.

A rain 200 forming in the ambient space of an OM 102 may be said to be suspended over (or under) its surface. The rain 200 formation process may take place within one or many evolution steps of the OM 102. When formation of the rain 200 is complete, the rain 200 may then be emitted from the OM 102 in an instant. A rain 200 may thus be used to sample and store a vibratory state of an OM 102. A rain 200 composed of a sequence of pulse fields sampled from an OM 102 over a period of its evolution may be emitted from the OM 102 in an instant. A rain 200 that is emitted from a first OM 102 to a second OM 102 may appear instantaneously in the ambient space of the second OM 102 upon reception. The rain 200 may thereupon immediately begin propagation with well-defined velocity normally towards a domain on the surface of the second OM 102. The rain 200 may propagate onto submanifold sections of which the component pulse fields of the rain 200 may be subsequently conformally or harmonically mapped from their respective canonical regular cross sections. The rain 200 may be absorbed at successive instants during a period of time as the OM 102 evolves.

A rain 200 emitted by one OM 102 and absorbed by another may be said to be attached, at both the emission and absorption ends of the rain 200, to each of the OM 102 via an attaching map. A separate type of attaching map (e.g., harmonic or conformal) may be used to attach the rain 200 to the OM 102 over which it is being absorbed as may be used to attach the rain 200 to the OM 102 over which it is being emitted. As previously described, a conformal or harmonic map may be used to implement a map attaching an OM 102 at one end of the tubular neighborhood of a rain 200 that is suspended over (or under), and being emitted or absorbed by, the OM 102. In other words, the rain 200 may be attached to the OM 102 via a conformal or harmonic map over an emission or absorption domain of the corresponding coupling interface of the rain 200.

As an OM 102 evolves over a period of time and rain 200 is emitted or absorbed, a domain on the surface of the OM 102 may also be in motion over the surface of the OM 102. The domain may be referred to as an interface of rain 200 or a coupling interface of the OM 102. Motion of coupling interfaces over the surface of an OM 102 may be described by orbital paths. The motion may be described by Lissajous curves over the simplicial OM 102 parameter space and may be generated by a group action in the tangent space of the OM 102. During motion of coupling interfaces along orbital paths in OM 102 tangent spaces, points may follow geodesic paths of shortest distance. The paths of shortest distance may be obtained using a heat method of distance computation. Specifically, the heat method may involve a three step process. Heat flow over the surface may first be integrated for a fixed time. The temperature gradient may then be normalized and negated to obtain a unit vector field pointing along geodesics. A Poisson equation may then be solved to obtain a function that recovers the target distance and whose gradient follows the unit vector field from the second step. Sound encoded in a rain 200 that is emitted from or absorbed by an OM 102 over a coupling interface that is in motion on its surface may be consequently frequency shifted as described by the Doppler effect with respect to a stationary source or sink of waves on the OM 102.

A pair of OMs 102 that are connected in synchronous cascade composition via an emitted/absorbed flow of rain 200 may allow sound to flow from one OM 102 to the other. This pair may be referred to as a COM. Further, OMs 102 between which sound may flow in the vibratory space-time of a sequence of COMs connected in a chain or complex of cascades may also be referred to as COMs.

A system of COMs may be modeled as a synchronous actor composition. In an actor model of a system of COMs, actors may be OMs 102 or other actors that perform conformal mapping at the interfaces of COMs or compression or encoding/decoding of rain 200. At each tick of a global clock, the reactions of actors in the composition may be simultaneous and instantaneous. Components of the system may be synchronous, side-by-side, and cascade compositions of the actors. A synchronous side-by-side composition of two actors may be a synchronous composition where inputs and outputs of the two actors are disjoint. The side-by-side composition may itself be an actor on the system. The reaction of this actor may be a simultaneous reaction of its two components. A synchronous cascade composition of two actor OMs 102 may be a synchronous composition where a rain 200 emitted by one actor OM 102 is absorbed by the other actor OM 102. The cascade composition may itself be an actor. The reaction of this actor may be a simultaneous and instantaneous reaction of its components. The reactions of its various components may be causally related. The order of reactions may be denoted by a set of time values in a super dense model of time

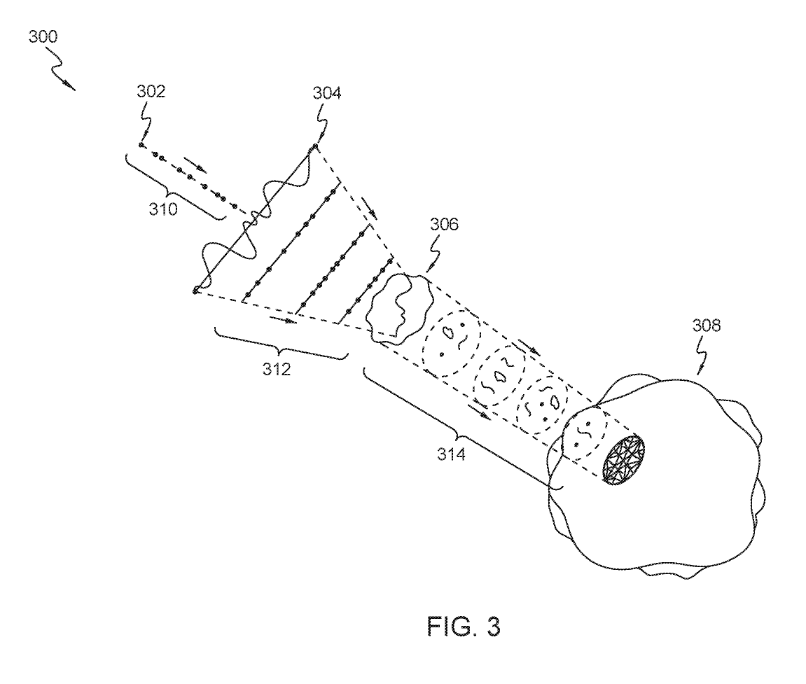

Referring now to FIG. 3, a diagram illustrating a system of COMs 300 is shown. FIG. 3 shows a system of COMs 300 that includes a zero-dimensional OM, 0-OM 302 (i.e., a point OM), an open one-dimensional OM, open 1-OM 304, an open two-dimensional OM, open 2-OM 306, and a spherical 2-OM 308. A first rain 310 may flow from the 0-OM 302 to the 1-OM 304, a second rain 312 may from the 1-OM 304 to the open 2-OM 306, and a third rain 314 may flow from the open 2-OM 306 to the spherical 2-OM 308.

The first rain 310 may be absorbed by the 1-OM 304 at a point roughly in the middle of its spatial extent. The first rain 310 may include an ordered sequence of pulses, which may be similar to a standard stream of PCM data because the 0-OM 302 is a point. The second rain 312 may be absorbed by the open 2-OM 306 over a curve that is depicted as lying in the interior of its surface. The second rain 312 may include an ordered sequence of pulse fields that are parameterized over a curved line segment. The third rain 314 may be absorbed by the spherical 2-OM 308 over a disk that is depicted as lying in the interior of its surface, and over which the underlying triangulation of the spherical OM is shown. The third rain 314 may include one or more pulse fields, as described above, that represent ordered vibratory states previously sampled from the open 2-OM 306.

FIG. 3 depicts the state of the system of COMs 300 at a given time. In other words, FIG. 3 does not explicitly depict a flow of pulses from the 0-OM 302 to spherical 2-OM 308. It illustrates information about the past state of the system of COMs 300, of which dynamical information may be implicitly determined. Although FIG. 3 shows a system of COMs 300 including the 0-OM 302, the open 1-OM 304, the open 2-OM 306, and the spherical 2-OM 308, a system of COMs 300 may include any type and dimension of OMs. Similarly, rain may flow from any dimension OM to any other dimension OM.

The various interfaces of rain connecting the OM may move along orbital paths in the corresponding OM tangent spaces by smooth transport using the heat method. The first rain 310, or column rain front, between the 0-OM 302 and the open 1-OM 304 may move along a length of the string of the open 1-OM 304. The second rain 312, or curve rain front between the open 1-OM 304 and the open 2-OM 306 may move along the surface of the open 2-OM. The third rain 314, or sheet rain front, between the open 2-OM 306 and the spherical 2-OM 308 may move upon the sphere of the spherical 2-OM 308. The OMs in the system may resonate depending upon their boundary conditions. Sound in the system may be transmitted from the point to the string to the open surface to the sphere via the flow of rain. The sound may propagate upon the OMs as they evolve.

A system of COMs may be a hierarchical composition of cascades. The flow of rain from one OM to another OM in the composition may occur in an extended causal order over a sequence of steps. When rain is absorbed by an OM in the composition, one or more firing functions may be executed. The one or more firing functions may be defined by a transition function derived from the inhomogeneous wave equation governing evolution of the OM. The one or more firing functions may operate on the OM sound field potential by the Laplacian. The sound field potential may be constrained by boundary conditions. Perturbation of an OM with one or more boundaries by rains absorbed over the interior of the surfaces of the OM may modulate the vibration of the OM.

A system of COMs may also be a symmetrical synchronous composition with a patchwork quilt-like structure. A system of COMs with a patchwork quilt-like structure may be used as extended spatial support for sound propagation. The coupling interfaces of OMs in the system may be bidirectional interfaces along the boundaries of the OMs. The coupling interfaces may modify the boundary conditions of neighboring COMs and may simulate computation of the Laplace operator over the extended dynamical surfaces formed by the COMs. This may be achieved by the establishment of equivalence or neighbor relations between simplices at the boundaries of COMs that are immediate neighbors in the composition. These neighboring COMs may share a natural boundary in the larger patchwork manifold. Synchronous evolution of the patchwork composition of COMs may be achieved by operation on the sound field potentials of a neighboring COM by a Laplace operator using a shared boundary state of the neighboring COM. Operation by the Laplace operator may be executed locally by one COM or in parallel by many of the neighboring COMs.

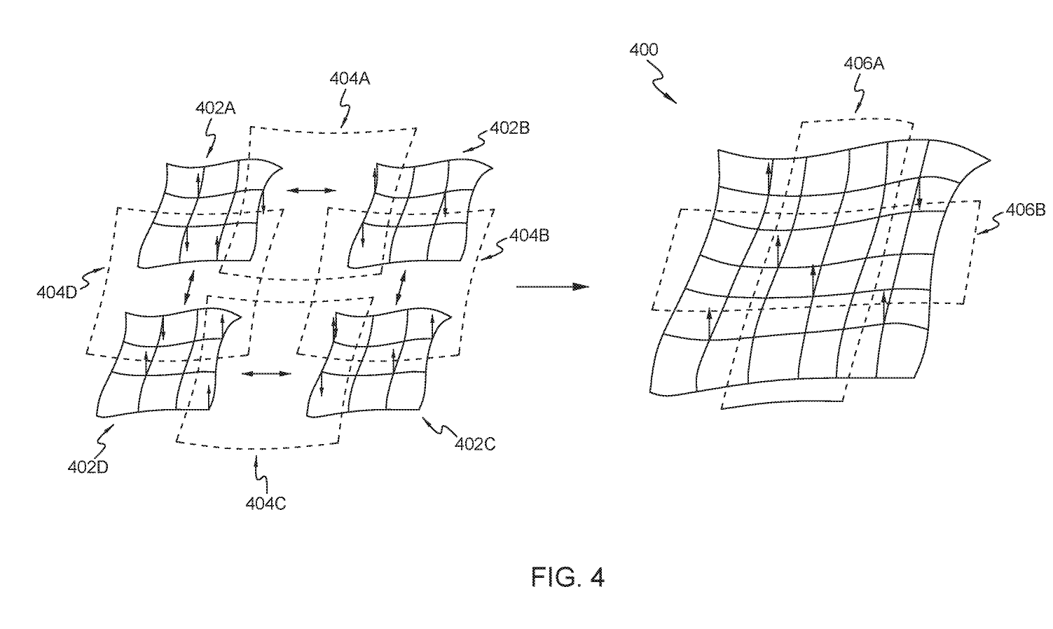

Referring now to FIG. 4, a diagram illustrating a system of COMs 400 with a patchwork structure is shown. A first bounded OM 402A, a second bounded OM 402B, a third bounded OM 402C, and a fourth bounded OM 402D are shown being joined to form in the system of COMs 400. It should be noted that first bounded OM 402A, a second bounded OM 402B, a third bounded OM 402C, and a fourth bounded OM 402D may be joined in any order, and the composites formed may then be joined. The first bounded OM 402A, the second bounded OM 402B, the third bounded OM 402C, and the fourth bounded OM 402D are shown as having a regular grid parameterization, but a triangulation may be shown instead.

The bounded OMs 402A-402D may be connected along their boundaries and subset of their interiors by bidirectional coupling interfaces. A first dashed bracket 404A shows a first neighbor state that is shared along sections where the first bounded OM 402A and the second bounded OM 402B are connected. A second dashed bracket 404B shows a second neighbor state that is shared along sections where the second bounded OM 402B and the third bounded OM 402C are connected. A third dashed bracket 404C shows a third neighbor state that is shared along sections where the third bounded OM 402C and the fourth bounded OM 402B are connected. A fourth dashed bracket 404D shows a fourth neighbor state that is shared along sections where the fourth bounded OM 402D and the first bounded OM 402A are connected. Once joined, a fifth dashed bracket 406A and a sixth dashed bracket 406B shows the shared sections of the bounded OMs 402A-402D.

The vertex that lies at the bottom right of the first bounded OM 402A, the vertex that lies at the bottom left of the second bounded OM 402B, the vertex that lies at the top left of the third bounded OM 402C, and the vertex that lies at the top right of the fourth bounded OM 402D may be joined into a single connecting central vertex. Any order in which the 4 instances of patchwork composition are carried out may result in these vertices being joined into one by transitive closure of the equivalence relation on connecting simplices. For example, if the first bounded OM 402A and the second bounded OM 402B connect to form one larger patch, and the third bounded OM 402C and the fourth bounded OM 402D connect to form another larger patch, and then these two larger patches connect, a single central connecting vertex may result and its neighbor state will be correctly defined.

The coupling interfaces may move by sliding along overlapping sections between neighboring bounded OMs 402A-402D in the composition. For example, the coupling interfaces may move by rotating locally in the tangent space of the patchwork surface. The bounded OMs 402A-402D in the patchwork composition may provide extended spatial support for sound propagation in the composition.

The ability to connect smaller surfaces together to create a larger surface may be a fundamental aspect of the technology. The type of connection produced by patchwork composition is different than that produced by cascade composition formed via rain. A cascade composition may induce an order in time, whereas the patchwork composition may extend a system spatially. The patchwork method for constructing larger simulated surfaces from smaller simulated surfaces may be enabled by operations on the simplices of surface meshes, such as the operation of joining two meshes together at a vertex, or along an edge.

The patchwork composition brings to bear the strength of the numerical simulation approach taken throughout the design of the cyber-physical vibratory medium by enabling the globally complicated computations, via a multitude of simple computations connected together in a precise way. A major limitation of conventional systems for spatial sound processing is that they typically rely upon closed-form analytic solutions for wave propagation in acoustic spaces. Because of this, they may need very precise global knowledge about the domain space. Even if, for example, there are two different spaces for which the analytic solutions of sound wave propagation are independently known and a new space is formed by joining or connecting the two spaces together, there may not be a corresponding analytic solution that is known for the new space that was formed. For example, there may be no efficient analytic solution for two chambers coupled by a connecting hallway (e.g., tube).

As a result of these limitations, conventional systems based on analytic approaches tend to be restricted in application to the computation of sound fields for rather trivial spaces, such as a box or a regular sphere. This is not a limitation in practice using the described numerical simulation because the solution for the acoustic wave equation on an arbitrary simplicial surface is given locally by the Laplace operator. Simulations of surfaces that are globally very complicated may be composed from smaller pieces that are locally simple.

As described herein, the cyber-physical system may provide the ability to simulate complex spaces using smaller patches that are independently simulated by computational platforms (CPs) that are distributed in a network and which coordinate the sharing of state using a communication protocol and message passing over the network.

In addition to distributing computation of a numerical simulation over a network using a communications protocol, absorbing boundary conditions (ABCs) may enable a numerical simulation of a class of domains which may not be accessible by conventional systems. While numerical simulation methods have been applied to the problem of acoustic wave propagation in closed domains, such as spheres, methods for the simulation of open domains, such as discs, may not be used in the art. For example, conventional systems may not provide a numerical simulation of sound wave propagation over a connected, open two-dimensional domain (e.g., in the shape of a disc or triangle, which may have disc topology). This domain may be important for a number of applications, such as simulating the sound field of a conversation between people on the same vertical level in a physical space. Simulation of these open domains may be enabled by application of the ABC method.

The patching together of two surfaces may include connecting simplices in the underlying meshes of their OMs. In this context, connecting may mean identifying certain simplices as the same. In an example, there may be two triangular OMs, each having an underlying mesh that includes: three vertices, three edges connecting different pairs of vertices, and one face which is bounded by the edges and fills in the interior of the triangle. The two OMs may be connected by choosing an edge from the mesh of one OM, and choosing an edge from the mesh of the other OM, and identifying the two edges as one and the same edge. This identification will form a composite OM in the shape of rhombus. This is an example of connecting two schema in a simplicial database along a simplex.

Different implementations of patchwork compositions may apply to different situations. In an example, a simulation of multiple OMs may be implemented by a single CP such that the underlying meshes of the OMs may be unified in memory. In this case, connecting or gluing simplices of the meshes together may be an operation that produces a single mesh in memory as the result. The two edges may be subsumed into one and the same edge and the two meshes may be joined into one mesh.

In another example, a simulation of the OMs may be implemented in a distributed way or in parallel by multiple CPs in a network. Meshes connected by patchwork composition may be disjoint in memory, but message transmission may be used to share mesh state and achieve a union of the meshes virtually. In this case, components of the virtually unified mesh may still be disjoint as they are computed and evolved by different CPs, but their operations may be unified via a protocol to produce a coherent virtual mesh.

There may be a number of strategies for establishing a patchwork type connection between a first OM and a second OM depending on what the sound field potential (SFP) of the COM will be, over the simplices in its underlying mesh where the first OM and the second OM are connected. For example, if the first OM and the second OM are the two triangles mentioned above, and they are to be connected along a common edge to form a rhombus, then a value of the SFP at the two vertices that are the endpoints of the edge along which the triangles are being joined to form the rhombus may be determined.

In an example, either the first OM or the second OM may decide what the value of the SFP is over the connecting simplices. In another example, the value of the SFP may be mutually agreed on using information from both the first OM and the second OM. The SFP over the connecting simplices in the composite mesh may be set as the corresponding value in the meshes of the first OM and the second OM wherever they agree and set as the zero-height elsewhere. Accordingly, if the first OM and the second OM have the same SFP over each of the vertices that are the respective endpoints of the edges that are being joined to form the middle edge of the rhombus, then those values may be preserved by the composition and fixed as the values at the vertices of the middle edge of the rhombus. Similarly, if the first OM and the second OM agree on only one or neither of the vertex potentials, then only one or neither of the values may be carried over to the composite mesh. This may correspond to taking the finite limit of a type of diagram in the category of simplicial databases.

Once a connection between OMs has been established, the implementation of the concurrent evolution of the OMs may be performed. This may be achieved using a communication protocol. The communication protocol may be used, for example at every coevolution cycle, to distribute the state that is necessary for each OM to compute the Laplacian over its section of the virtual unified patchwork OM, and do this in a timely and deterministic manner. Using clock synchronization and Ptides safe-to-process analysis, the protocol may ensure that OMs in a patchwork composition do not fire their respective transition functions and evolve before the distributed neighbor state at their specified connecting simplices has been established, or a given intervalic bound has elapsed.

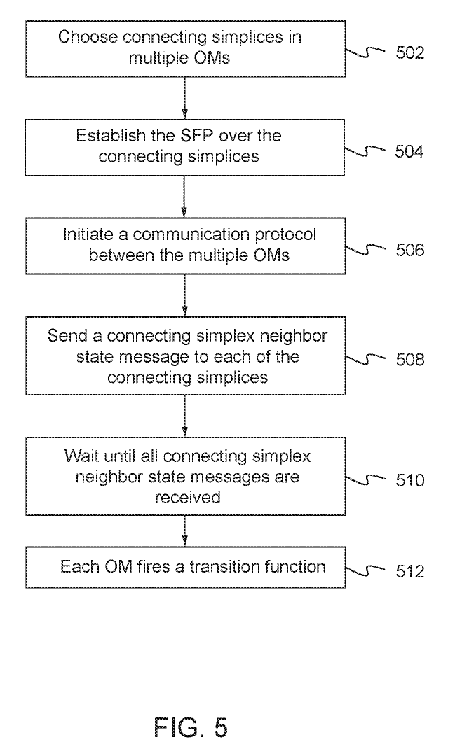

FIG. 5 is a flowchart illustrating the steps for forming and evolving a patchwork OM (i.e., system of COMs). In step 502, connecting simplices in multiple OMs may be chosen. This may be done, for example, by drawing paths between designated simplices in a schema. In step 504, the SFP over the connecting simplices may be established. In step 506, a communication protocol between the multiple OMs may be initiated. In step 508, a connecting simplex neighbor state messages may be sent to each connecting simplex of each OM of the multiple OMs. The connecting simplex neighbor state messages may include one or more of the SFP, side lengths, and angles of neighboring simplices needed for cotangent formula. In step 510, for each OM of the multiple OMs, the system of COMs may wait until time t+d+e or until all connecting simplex neighbor state messages from neighboring patches have been received. In step 512, for each OM of the multiple OMs, the transition function may be fired for the OMs to coevolve.

Two OMs connected together via patchwork composition may already have ABCs applied to their surfaces. An ABC that is in application over simplices that are initially bounding simplices and are then chosen as connecting simplices may be elided or automatically removed over the connecting boundary simplices. In general, when two OMs connect in a patchwork composition, all or part of any ABCs or other boundary conditions applied to their simplices may be removed.

If an OM executing coevolution using the communication protocol described above does not receive the necessary neighbor state data from those other OM that have been established as its neighboring patches within the interval of time specified by the Ptides safe-to-process analysis described below, then it may automatically reapply an ABC or other boundary condition over the boundary simplices that were established as connecting simplices. In other words, the boundary simplices of the OM may revert to regular boundary simplices, and the OM may evolve independently.

Evolution and coevolution of OMs under patchwork composition may be robust to unexpected delays in the transmission of information. If the intervalic time bound on evolution of an OM in a patchwork composition elapses before all connecting simplex neighbor state messages have been received and the OM reestablishes an ABC over those connecting simplices and evolves, a minimal fixed amount of information may be absorbed and disappear at the boundary of the OM. If the patchwork connection is reestablished within a given interval of time, then the bulk of the information that propagated over the interior of the OM may have been retained and may continue to propagate over the connection between the OMs.

Synchronous evolution of the collection of OMs may be achieved by operating on the sound field potentials of neighboring COMs locally by a Laplace operator using the shared boundary state with the neighboring COMs. A sheaf may be used to collate the results of local patchwork computations into a global computation. The Laplace operator may be computed by one COM or in parallel by many of the neighboring COMs.

In the synchronous and reactive model of a system of COMs, one or more OMs in the system may evolve at the same fundamental rate. In a real world system, different clocks in the system may evolve at different rates. Therefore, reactions of components in a system of COMs may not be simultaneous and instantaneous. Nonetheless, modelling systems of COMs as though they preserve the properties of synchrony and reactivity may enable determination of correct and incorrect behavior of the system. A generalization of a synchronous reactive (SR) model may be used to describe systems of COMs in the real world, which may preserve the system properties of synchrony and reactivity as a function of computational resources. When used for realization of a system of COMs using a given execution engine, this may ensure that the desired properties and specifications may be met to within a bounded margin of error.

The SR model may be a discrete event (DE) model of computation or a DE modeling paradigm. In a DE model of a system of COMs, events may be marked with a time stamp or value in a model of time. A DE model may include a network of actors. An actor may both react to input events and produce output events in a time-stamp order. Actor inputs and outputs may be signals composed of communication events between the actors. An actor may store the events on an event queue or signal buffer, which may be a list of the events in the time-stamp order.

A variant of the above modelling paradigm may be a programming of temporally-integrated distributed embedded systems (Ptides) modeling paradigm. A Ptides model of a system of COMs may use a semantic notion of time that is multiform and super dense. Time at different points in a model may progress at different rates. Values of time may be tuples that encode both model time as well as a micro-step or time index, and may be compared lexicographically and ordered both by model time and microstep. Clocks in a Ptides model may be synchronized, and a safe-to-process analysis that leverages known bounds on error in measurements of time may be used in order to ensure deterministic behavior of an implementation of the model.

The model of time used in Ptides may satisfy properties that are important for a semantic notion of time. For example, the precision with which time is represented may be finite and the same for all observers in the model. The precision with which time is represented may be independent of the absolute magnitude of the time. The addition of time may be associative. Any observer of time in the model that includes a sequential process, or sequence of state changes, may observe monotonically increasing values of time. The model of time may enable coherent or well-formed notions of event ordering and simultaneity in the model, even if clocks at different points in the model run at different rates.

A Ptides model of a system of COMs may be faithful to the idealized SR model of the system under certain assumptions about the execution engine or physical realization implementing the model. For example, it may be assumed that clocks in the system are synchronized with a known bound on the synchronization error. It may be assumed that every communication channel in the system may have a known bound on its latency. It may also be assumed that the time taken by any computation that may affect the physical world may have a known bound. These assumptions may be satisfied using methods known in the art of temporally-integrated distributed embedded systems, such as a precision time protocol (PTP) for clock synchronization. Clock synchronization may enable temporally coherent composition of acoustic media.

The Ptides modeling paradigm may be a deterministic cyber-physical system modeling paradigm. A cyber-physical system may be an orchestration of computation and physical systems, an integration of computation with physical processes, and a system composed of physical subsystems together with computing and networking. In a cyber-physical system, computers and networks may monitor and control physical processes and the computational and physical processes may affect one other in feedback loops. A cyber-physical system may include physical plants, which may be physical processes and systems, including physical acoustic media evolving continuously in the real world. The cyber-physical system may also include CPs, which may be systems composed of computers and one or more sensors, actuators, transceivers, and transmitter input and output ports. Components of the cyber-physical system may be dynamical systems that evolve continuously (e.g., as in the case physical acoustic media evolving in the real world), discretely (e.g., as in the case of simulated acoustic media), or in a hybrid of continuous and discrete evolution (e.g., as in the case of higher-level OM formed from the interconnection of physical OM and cyber OM that are coupled and coevolve). The cyber-physical system may also include a network fabric, which may be a system for communication between the CPs. The network fabric may be composed of wired and/or wireless connections.

The CPs may be connected to the physical plants via one or more transducers. The CPs may be connected to one another via the network fabric. The CPs may be interconnected to form new CPs. The interconnection may be coherent with respect to nesting of wiring diagrams. An individual CP that is able to interconnect in this manner may be defined in terms of internal sheaves as a type of abstract process known in the art of dynamical systems as a synchronous machine.

A Ptides model may be used to define the operational semantics of a cyber-physical system for realization of a system of COMs. Operational semantics expressed using the model may assume reliable and effective construction of the CP and network fabric. Embodiments described below may include methods for modeling and implementation of a cyber-physical system for realization of a system of COMs. The CPs may be used for implementation of OMs. The network fabric may be used to support signal flow between the CPs for synchronous composition of the OMs via emission and absorption of rain.

The construction of the CPs in the cyber-physical system may involve the use of one or more processors. The one or more processors may be general purpose, such as those used in consumer devices. The one or more processors may be specially designed for precise, predictable, and repeatable timing and performance. For example, the one or more processors may be in precision timing (PRET) machines with support in their instruction set architectures for explicit control over timing. In addition, systolic and wavefront processors and arrays may be used, for example, to execute rules for finite-step evolution by discrete Laplace operators. These systolic and wavefront processors may include networks of data processing units that may fire synchronously or asynchronously.

A cyber-physical system may include CPs that are constructed using more conventional components, such as extended finite state machines whose instruction set architectures do not provide explicit control of timing. This cyber-physical system may rely upon auxiliary operating systems for querying and control of temporal behavior of hardware components.

A cyber-physical system used for realization of a system of COMs may include simplicial data structures that may be distributed and stored over the CPs. In particular, a simplicial database may be used. The schema of the simplicial database may have a natural geometric structure of an underlying simplicial set. Data in the database may be associated with state in the system of COMs. Data transformations may be associated with the system of COMs changing through time, and may result from application of database operations instructed by the execution of application-level programs by the cyber-physical system. The database may be a system comprised of mesh or table structures connected together over an underlying simplicial set.

The data structure and system objects used to achieve manifold modeling may be referred to as a mesh. Meshes may represent geometry and topology of manifolds using simplicial complexes, cell complexes, and closure-finite weak topology (CW) complexes. The connective and geometric information of a mesh may be decoupled by use of an abstract simplicial complex that may determine an associated geometric simplicial complex. A mesh may represent a two-dimensional manifold using a triangle mesh or simplicial 2-complex. A mesh may represent a one-dimensional manifold using a simplicial 1-complex. Meshes may include implementations of simplicial and other complexes using structures such as incidence simplicial data structures, compressed simplex trees, maximal simplicial complexes, simplicial array lists, quad-edge, corner-edge, vertex-edge adjacency, and half-edge data structures.

Meshes may include additional structures for representation of information that may be linked to the complexes and may facilitate processing of the manifolds. For example, meshes may include adjacency, incidence, and degree matrices associated with a complex. Meshes may associate primal simplicial complexes with their duals. Meshes may enable construction of k-chains and co-chains of simplices from complexes, and may define boundary and co-boundary operators over the simplicial manifolds. Processing of discrete differential forms and vector fields over simplicial manifolds may be achieved using a discrete exterior calculus. Meshes may include construction of an exterior derivative operator, which may operate on differential forms defined over a simplicial manifold.

Methods based on construction of a discrete simplicial connection and discrete covariant derivative may be used to process simplicial manifolds. In these methods, a local reference frame may be associated to a simplex of a simplicial manifold. For a given set of simplicial frames, a discrete simplicial connection may be constructed using a set of parameters such as rotations between vertices, vertices and edges, and vertices and triangles. A discrete simplicial connection may enable parallel transport along a simplicial manifold and may enable the construction of a discrete, linear, and metric-preserving covariant derivative. The discrete simplicial connection may be given a measure of curvature. The covariant derivative of a simplicial manifold may be used to obtain explicit expressions for differential operators, such as divergence and curl operators. Explicit expressions for energies of the simplicial manifold, such as the Dirichlet energy, may be obtained using the methods.

Functions may be defined on simplicial manifolds. A scalar field may be defined on a simplicial manifold by associating a scalar value to a vertex of the manifold. The gradient of scalar fields on simplicial manifolds may be taken and vector spaces or vector fields may be defined over the complex. Normal and tangent vectors may be defined at the vertices of a simplicial manifold. Scalar and vector valued fields defined on simplicial manifolds may include normal and tangent spaces and height fields. A height field may be a scalar field that represents the displacement of a simplicial manifold in the normal direction. Tensor fields may also be defined over simplicial manifolds. A metric tensor may be defined at a point on a simplicial manifold. Scalar and vector values may be defined at points on a simplicial manifold that are not incident with vertices via coordinate parameterizations or extensions over the manifold. This may be done, for example, using a barycentric coordinate parameterization.

Discrete transformation of functions on simplicial manifolds may be implemented using a variety of methods, including finite element analysis, finite difference analysis, finite volume analysis, and weighted-residual analysis. The simplicial manifolds may represent the 0-level sets of the functions.

Evolutions of OMs may be described by wave equations of various types. The heart of any wave equation may be a Laplace or wave operator. A function on a simplicial manifold may be evolved according to a homogeneous wave equation driven by the Laplace operator. Construction of a Laplace operator for simplicial surfaces may be based on a cotangent formula. The numerical stability of transformation of functions parameterized over the simplicial surface may be preserved and optimized by an evolution operator, since the simplicial geometry of the surface may not approximate a smooth setting. To address the issue of the stability, refinements or improvements may be periodically applied to a simplicial surface. For example, an edge-flipping algorithm may be used to augment the well-known cotangent Laplace operator, which may compute an intrinsic Delaunay triangulation of the surface. This may minimize error in an energy, such as the Dirichlet energy, of a function on the surface. The resulting Delaunay triangulation may be well-formed and better conditioned than the original simplicial surface in further processing of the function and simplicial manifold for more stable results.

Other methods may be used in order to achieve stable numerical transformation of functions on simplicial surfaces. A general, versatile, scalable, customizable, and local method for adaptive refinement and quality-improvement of simplicial surfaces and functions thereupon may be the AFEM. Adaptive refinement may keep sound propagation well-conditioned. The AFEM may be used, in conjunction with a discrete Laplace operator, to achieve stable numerical evolution of a function on a simplicial surface. Stable evolution of a function on a simplicial surface by a homogeneous wave equation may be achieved using a two-step, cyclic algorithm applied to the function and surface. In a first step, a discrete Laplace operator may transform the function on the simplicial surface using a cotangent formula. In a second step, a self-adaptive mesh refinement algorithm may update the geometry and connectivity of the underlying simplicial manifold based on an a posteriori estimator of error in the energy of the function as parameterized by the simplicial surface.

The AFEM may involve an energy minimization process. The discrete energy of a function on a simplicial surface, or triangle mesh, may be minimized by changing the surface and thus the parameterization of the function. In the case of a simplicial surface with a boundary described by a function referred to as g, the AFEM may compute a minimal energy parameterization of the function over a space of admissible states. The space of admissible states may be the space of continuous functions on the surface that coincide with g on the boundary such that the graph of the function over one or more triangles of the simplicial surface is flat. The energy of the function may be obtained by integrating the square of the gradient of the function, evaluated triangle by triangle, over the surface domain. The discrete minimizing function, which may give the admissible state with the smallest discrete energy, may be computed by solving a linear system of N equations with N unknowns. The value N may be the number of interior vertices in the problem domain. In order to ensure tractability of the computation, the AFEM may provide a method for optimal discretization of the mesh.

An error of the discrete minimizing function may be the absolute value of the difference between its energy and the true energy of the minimizing function in the continuous setting. The error may be reduced by increasing the number of vertices of the simplicial surface parametrizing the function. For example, the number of vertices may be reduced such that they are evenly distributed in the surface domain. However, this method of error reduction may not be efficient, because it may use more vertices than necessary and the computational cost of transforming the function over the simplicial surface may grow with the number of vertices. The AFEM may, given some tolerance for error, compute the minimizing function over the simplicial surface, such that the function has error less than the tolerance and the simplicial surface has as few vertices as possible.

The AFEM may optimize a simplicial surface using an a posteriori error estimator. This error estimator may be computed by integrating, over the simplicial surface, how much the piecewise constant gradient of the minimizing function on the surface varies between adjacent triangles. This may be weighted by the lengths of the edges adjoining the triangles. Contributions to the overall error estimate may be evaluated locally, and regions of triangles with high error estimator contributions may be selectively refined such that the overall simplicial surface is adapted in an optimal way.

In an example implementation of the AFEM, a discrete minimizing function may be computed over an initial simplicial surface using a linear solver and the error of the function may be taken. A subset of the triangles in the simplicial surface may be chosen for which the sums of the individual error estimator contributions over the triangles is greater than a percentage of the total of all estimator contributions. The subset may contain as few triangles as possible. The triangles in the subset may then be refined. The above steps may be periodically repeated to achieve adaptive refinement of the simplicial surface.

The AFEM may also be used for a simplicial surface without boundary. In the case without boundary, the energy of a function on the surface may be defined in the same way as in the case with boundary, namely as the integral of the square of the gradient of the function. However, minimizing the energy may be subject to additional constraints. In an example, a function may be defined over a closed surface in the shape of a sphere. Minimizing the function may then involve finding the first eigenfunction of the Laplacian operator. A discrete approximation of the energy minimizing function may be calculated using the same methods described above, but with the additional constraints that the function is integrated to zero over the surface domain and the integral of the square of the function is equal to one. The function may integrate to zero when paired with any other functions previously found to solve the Laplace equation.

Accordingly, evolution of an OM by a homogeneous wave equation may be achieved using a two-part, cyclic process. A Laplace operator for simplicial surfaces may be used to drive the oscillations, and the AFEM may be used to stabilize the manifold. Periodic application of the evolution process may cause waves in the sound field potential to propagate as digital geometric vibrations of the manifold.

A simplicial manifold used to parameterize an OM sound field potential may consist of a finite number of elements (e.g., simplices). As such, it may not be possible to accurately represent an OM of infinite spatial extent, such as an infinite planar OM or an infinite spherical OM, using the above methods alone. A simplicial surface parameter space of an OM sound field potential may contain a set of simplices designated as the boundary of the OM. For a simplicial surface with a boundary, the sound field potential on the boundary may be determined by conditions such as Dirichlet conditions and Neumann conditions. The conditions may prescribe that the sound field potential along the boundary take on a fixed value, or that change in the potential along the boundary take on a fixed normal derivative. Different conditions may be used to determine the sound field potential at different points or components of the boundary in a piecewise mixed boundary condition.

The initial boundary conditions and initial sound field potential of an OM may together be referred to as the initial conditions of the OM. The vibrations of an oscillating membrane with a fixed boundary (e.g., a drum) may be described as linear combinations of eigenmodes determined by the membrane initial conditions. The membrane eigenspectrum may dominate its vibration due to resonance of waves that propagate on the membrane and reflect at its boundary. The vibrations of an OM may be constrained or limited due to resonance. In some cases, resonant evolution of OM may be desirable, such as for the purpose of synthesizing the sound of a drum. However, in other cases, it may be desired to evolve OM not constrained to undergo self-resonance.

Computation of OM that may be effectively unconstrained to resonate at particular modes or frequencies may be achieved by use of transparent or ABCs or artificial attenuating layers, such as the perfectly matched layer (PML). The methods may enable approximation of infinite vibrational domains, such as an infinite planar vibrating membrane, using finite computational resources, and their application may provide support for composition of OMs that may be overlapping. The OMs may be connected together into larger surfaces. OMs augmented by ABC may function in a manner analogous to open sets or patches of a topological space, and may be connected together to form surfaces that they collectively cover. The ABCs may be implemented using, for example, various higher order ABC (HOABC) and the improved Higdon ABC (IHABC). The methods may provide approximations of total absorption. The approximation may be customized and adjusted by modification of the order of the ABC. Methods based on a Perfectly Matched Layer (PML), such as pseudo-spectral time-domain (PSTD) methods, may also be used to implement ABCs.

Open two-dimensional (disk-shaped) acoustic media may be simulated using an ABC. This may enable a more computationally-tractable numerical method for processing two-dimensional spatial sound fields (e.g., a floor of a room or hall, which may capture important spatial cues).

The ability to apply an ABC to a dynamical surface with a boundary may mean the surface can be considered open with respect to patchwork-type composition in which ODS interior and boundary state is overlapping and shared. In particular, for a dynamical surface composed of smaller dynamical surface patches interconnected in a quilt-like structure, the state evolution of each individual patch may be computed in parallel using the interior and boundary state information that is identified as overlapping and shared with other immediately neighboring individual patches. The results of the individual state evolution computations may be collated. Thus, the ODS may be composed to form a larger ODS in a manner analogous to how a topological surface (with evolution driven by a Laplace operator) may be constructed from a collection of smaller, open surfaces (upon which the Laplacian acts locally). It should be noted that a dynamical surface for which the topology of the underlying mesh is closed (e.g., a sphere) may still be open in the sense that it can send and receive signals as rains from other ODSs.

Boundary integral operators may be coupled with the finite element methods for wave propagation on an OM as described above. The boundary integral operators may make use of tangent space vectors perpendicular to a bounding curve on the OM simplicial manifold. The boundary integral operators may specially treat corners or cusps where vectors perpendicular to the boundary may not be well-defined.

A PML may be coupled with an OM subspace such that a finite element differential operator, oriented in the direction from which the PML is to annihilate, may multiply outgoing waves by a complex attenuating component. The attenuating component may be set equal to zero at the boundary of the subspace, and the amplitude or weight of its attenuating effect may gradually increase towards the edge of the PML. The amplitudes of waves outgoing from the bounded region may be exponentially attenuated to lie within a small and bounded error margin.

Construction of artificial boundary operators to implement an ABC or PML on an OM may allow an OM to model an acoustic medium that is not a resonant acoustic medium with a fixed boundary. Accordingly, the OM may act as a propagator of pure sounds unmodulated by waves due to resonance. For example, a spherical OM may be modified to include an absorptive boundary curve on its surface. An equatorial line segment or circle that may effectively absorb some or all waves going from one to the other hemisphere may be created by coupling ABC or PML boundary operators along the line segment or circle. The ABC and PML for OM may also be useful for the purposes of security and privacy, as described in further detail below.

An OM may be implemented by processing a mesh that is periodically transformed by a finite element Laplace operator for simplicial surfaces. Absorbing or transparent artificial boundary operators may be used. In addition, a self-adaptive resimplexification method for sound field potential energy minimization may be used. Implementation of a full system of COMs by a cyber-physical system may involve two or more instances of OMs implemented via mesh memory and processing by CPs in a set of CPs connected by a network fabric over the set. Coordination of the OMs and a signal flow protocol for communication may be used to achieve coupling and synchronous composition into a system of COM. A safe-to-process analysis may be used to ensure implementation of the system of COMs by a deterministic CPS.

Mesh data structures may be connected in a simplicial database over a network of CPs. Data stored at individual CPs in the network may be represented in memory either using simplicial methods or in a table format. The two representations of CPs may be equivalent. A database management system may be used to process the mesh data by handling execution of operations applied to the database. A graphical language for table manipulation in simplicial databases may be used. The mesh data structures connected over the CP network may be mutated, changed, duplicated, deleted, joined, projected, and inserted. Unions and meeting points may be taken.

The various operations on the mesh data structures may correspond to universal categorical constructions and may be obtained as limits and colimits of diagrams in the category of simplicial databases. The mesh data structures may be operated on by the database management system automatically during execution of an application-level program for implementation of the cyber-physical system. This may be performed according to the operational semantics of a Ptides model. The mesh data structures may also be operated on by users of the cyber-physical system via a graphical language for table manipulation in the database. Transformations in the data and the underlying simplicial data structures may correspond to evolution of a system of COMs as implemented by the cyber-physical system. Implementation and utility of a simplicial database of the mesh data structures connected together and stored over the CPs may rely upon an underlying network of the CPs. The network may facilitate distributed memory and evolution of the mesh data.

A simplicial database may facilitate storage and manipulation of the mesh data structures, which may implement simplicial complexes, as well as the tree data structures in the overlay mesh network of interleaved distributed minimum spanning trees (k-dMST). The trees may be associated with the mesh structures and may assist in the execution of database operations by directing and facilitating optimal transport for communication over an underlay network. The overlay network of k-dMST may augment the conventional simplicial database by coding the connection patterns between CPs in a network and facilitating optimal execution of database operations by the CPs. The dMST may have the natural geometric structure of a forest, and as such may embed the patterns of patchwork-type or cascade-type interconnections of ODSs implemented jointly by CPs over the network. The category of forests may embed the category of simplicial and generally of dendroidal sets.

The schema of a simplicial database may have the natural geometric structure of an underlying simplicial set. The geometry of the schema may be seen as a way of keeping track of relationships between distinct tables in the database, and may be seen as a system of foreign keys and as an Entity-Relationship diagram for the schema. The shape of the schema may intuitively represent the shape of a network of OMs implemented over a network of the CPs. The data on the schema of a given simplicial database may be given by a sheaf of sets on that schema. Operations on sheaves may allow transport from one schema to another in a functorial way.

A variant of simplicial sets may also be used as the schema. Vertices of the simplicial set may be labeled and each label may be an element of a set of data types. Tables in the database may be connected together when the corresponding simplices are connected. Simplices may only be connected if their labels match.

Various data types may be used corresponding to different applications of ODSs. There may be a primary data type and default label. The primary type of data stored in the tables may be sound field data, which may be stored over intervals of length covering one or many ticks of a global clock, and which may be changing in time.

By default, data stored over the underlying mesh of OMs modeling ODSs may be of the same purely numerical type and compatibility of the data types may be satisfied as a vacuous property. In other, more specialized cases, data of additional types may be stored and manipulated to facilitate control of the sound field data. Schema vertex labels may be used for which connection of simplices in the database may be appropriately restricted. For example, membership in network of ODSs may be restricted according to a number of measures, and an ODS may only be able to interconnect with other ODS in a network of which it is a member. Each ODS network may have a unique identifier or title, which may be represented, for example, as a string of characters. Simplices of the underlying mesh for a pair of ODSs, each having membership in a given set of networks, may be labeled with the network titles or IDs, and may be connected together only when a specified network ID is shared in common. Membership in a network of ODSs may be restricted based on, for example, a minimum allowed evolution rate, a minimum allowed throughput, a maximum allowed latency, or a payment of a sum. Otherwise an outside ODS may not interconnect with other ODSs in the network.

The category of simplicial databases may be closed under all limits and colimits. The categorical constructions correspond to operations such as joins and unions, and may be used for manipulation of the mesh data structures stored as tables in the database and operations on ODSs such as connection along one or many tetrahedral faces of the ODSs into a patchwork quilt-like structure. Other queries, such as projections, insertions, and other special kinds of unions, selections, and deletions may also be built into the database and used to manipulate the mesh data structures, and thereby operate on the corresponding ODSs.

For example, given a database (X, K, r) and a subschema X′, a projection query may be given by restricting the sheaf K and the map of sheaves r to the subschema X′. Given two databases with the same schema, an insertion query may be given as a union of the two databases, where one of the databases consists only of a single row. Various select queries may be given as certain fiber products. The queries may have certain desirable properties. For example, a deletion of entries over a subschema may cascade up the hierarchy of subschema in a well-defined manner (e.g., deleting entries in larger schemas when they refer or point to the deleted entries.).

Each simplex in the simplicial set representing the schema of a simplicial database may correspond to a table in the database. The geometric nature of the schemas may be effectively exploited. In particular, each simplex may be represented as a polygonal tile. A process of mixing and matching tiles may be thought of as a process of assembling custom databases. Queries on the database may be performed by drawing paths through the resulting tile formations, selecting records at start-point of the path and retrieving corresponding records at its end-point.

Simplicial databases may be visualized using a mathematical functor known as geometric realization. Mixing and matching tiles in the database, as well as drawing paths through the database to indicate queries, may be represented visually and may implemented on a modern computer. For example, a user may indicate aspects of the database using a computer mouse or more general user interface device. Operations on the database may be performed by clicking on simplices, dragging tiles, or drawing curves through a schema. These phrases may have a precise formal meaning when interpreted using the functor.

Tiles may be added to an existing database to create a new one. Curves may be drawn in a schema that indicate the process by which data one of type will be used to find corresponding data of another type. Both abilities may rely upon the ability to visualize simplicial databases. While simplicial databases may be purely mathematical objects, they may be visualized using the mathematical geometric realization functor from the category of simplicial sets to the category of topological spaces. In particular, any object X that is an element of the set of objects in the category of semi-simplicial sets may be obtained as the colimit of the diagram of simplices of X. This may be formalized using a Yoneda functor, which is fully faithful. The Yoneda image of any finite non-empty set A may be visualized as the polygonal hull of A as a set of vertices. Thus a one-point set may be seen as a vertex, a two-point set seen as a line-segment, a three-point set seen as a triangle, etc. Using the Yoneda imbedding, the isomorphism between an object X and the colimit of its diagram of simplices may display the object X as the union of the above shapes. This visualization may be made precise using the geometric realization functor.

A variant of simplicial sets may be used in the formalization of a simplicial database. The visualization process described above may be altered to support usage of simplicial sets augmented by vertex labels in a set, DT, of data types. In the alternative visualization process, the category of semi simplicial sets may be replaced by the category of presheaves on the comma category of finite non-empty sets and monomorphisms between them, over DT. Objects may be standard simplices, but every vertex may be labeled by a data type. Morphisms may be standard but with the added requirement that vertices may be sent to vertices of the same data type label.

As a symmetric semi-simplicial set, the schema X of a simplicial database may be visualized by connecting dots (0-simplices), edges (1-simplices), triangles (2-simplices), tetrahedra (3-simplices), and higher-dimensional tetrahedra (n-simplices with n>3), using conventional requirements on pasting, or gluing, simplices together, as well as any additional requirements induced by associating labels to the vertices of the simplicial set. Different simplices of a schema X may correspond to different tables in the database. For example, an n-simplex may correspond to a table with n+1 column (i.e., one for each vertex) and with attributes specified by the labels of the vertices.

When viewing a schema of the database, higher-dimensional simplices may be visualized on a computer display device using a variety of methods. Slices of higher dimensional simplices may be displayed and views of the simplices may be rotated. Various types of projections onto lower-dimensional display surfaces may be used. Holographic techniques may also be used to render higher-dimensional simplices into a three dimensional display.

The schema of a simplicial database may represent the corresponding table types, but it may not have data in it. A user may click on a simplex in the schema in order to see the corresponding table associated to the simplex. The separation between the schema and the data in a simplicial database may be represented mathematically as the separation between the simplicial set X and the sheaf of data.

The simplicial model may provide the ability to quickly build custom databases by mixing and matching tiles, which are given as simplices. A user may select a tile from a set of tables and may drag various tiles from a library of tiles to a workspace and connect them together. Tiles may be imported from sources outside a user's personal library of tiles, and may be made available for purchase. The connection of two tiles that share a common face may be obtained as the limit of a diagram in the category of simplicial databases.

The simplicial database model also affords the ability to craft intuitive queries by drawing paths over a visualization of the database. For example, given a table T1 with attributes A, B, a table T2 with attributes B, C, D, and a list of data of type A, a user may select all data from T1 that conforms with the data in the list. The user may use the selected data to query table T2, to locate all the corresponding data of type C, D. In the simplicial model, construction of this query may be highly intuitive, as follows. The schema for the situation consists of an edge and a triangle. The edge may have vertices labeled A and B, the triangle may have vertices labeled B, C, and D. The edge and the triangle may be attached at B. Upon choosing a set of data of type A, the user may click the schema at the vertex A and drag a curved line through the schema that ends at the 1-simplex C, D. A simplicial database may then return the desired data of type C, D. Drawing a continuous path through a visualization of a (symmetric semi-) simplicial set X may be considered a zig-zag of morphisms in the category given by the Grothendieck construction on X. In particular, a path through X induces a zigzag of tables in the form of projects and selects.

A vertex in a simplicial set may represent the schema of a database and may correspond to an individual CP. More generally, an n-simplex may represent the schema of the database and may correspond to the individual CP. The vertex may have a label referring to some type of information about the CP. For example, the label of a vertex may refer to the location of a CP, or the frequency bands on which the CP may transmit and receive signals Two simplices may be connected if, for example, a path or connection exists between them having a latency less than a certain length, a throughput greater than a certain rate, or a spectrum fibering over a given sequence of bands, such that they can send and receive messages as needed to jointly execute an instruction involved in the concurrent simulation or implementation of an ODS.

The table associated with a simplex may store data corresponding to the connections existing between the simplex and other simplices to which it is connected in a complex, which may be stored and managed by other CPs, The table may also store data, in the form of spectra, signals, or time-frequency distributions, on the sound fields of the ODS associated with complexes of which the simplex is a part.

Tiles in a simplicial database may correspond to well-known mathematical operations, such as addition. For example, the operation of adding two integers together may be represented as a table with three columns, each of which may have a datatype of integer. In any row, the sum of the integers in the first two cells may be the integer in the third cell. A finite section of this table, of appropriate length, may be presented for view at a given time.

Similarly, there may be tiles corresponding to operations involving the emission, harmonic or conformal mapping, absorption, and application of group actions to the coupling interfaces of, rains between OM. The tiles corresponding to such rain formation operations may be grouped together and stored in the database. Each OM and system of COMs may also have a schema corresponding to its underlying simplicial complex. These schemas may also be grouped together and stored in the database.

A cyber-physical system network may allow for signal flow between one or more CPs locally executing evolutions of OMs. One or more CPs may be located in various physical spaces and may connect with one another via wired or radio-frequency (RF) signal transmission and reception. Signal flow transfer over the network fabric may enable coordinated and concurrent computation by the CPs.

The physical network formed by the wired or wireless connection of the CP may be referred to as an underlay network. The underlay network topology may be referred to as the physical network topology. Overlay networks may be constructed from logical links between nodes in the underlay or physical network. The underlay and overlay networks may be represented using connection graphs, in which CPs may be the nodes or vertices, and connections between them may be edges. One-way connections between nodes may be represented by directed edges in the graph. Weights or costs, which may encode quantities such as bandwidth or capacity, distance or latency, and stability or fidelity of network connections, may be represented by scalar values associated to the graph edges. Signals created or destroyed by the CPs may be represented by sources or sinks in the graphs. A network formed by the CPs may be a flow networks represented by a flow graphs or directed weighted graph with sources and sinks.

The topology of a network of the CPs may fall upon a spectrum. On one end of the spectrum, the underlay or physical network may have a purely centralized or star topology. The network may consist of a number of satellite nodes connected to a single central node. The central node may store a complete memory of the system or network state and may administer control over logical connections and communications between other nodes in the network. The central node may control data queries and put, get, actuation, and sensing events that may occur at the satellite nodes. These events may be communicated among the satellite nodes via routing through the central node. Networks with other topology such as tree topology may be built from star networks. In the case of centralized organization of the CPs, various structures, methods, and protocols used for centralized computer networks and computer communications may be used to achieve effective and reliable network formation and communication between the CPs.

Alternatively, the CPs may be connected in distributed networks. For example, the CPs may be mobile devices, between which communication potential may exhibit spatiotemporal and spectral variation and fragmentation. The CPs may communicate over ad hoc local channels of communication. The CPs may store a partial memory of a global network or system state. The CPs may enact partial processing of global network or system computations. The CPs may communicate directly with one or more nodes in the network, which may be neighboring nodes.

A distributed hash table (DHT) may be used for scalable distributed memory and may be used for construction of additional data types and structures, such as distributed sets, lists, and trees. The DHT may use consistent and rendezvous hashing techniques based on various topological structures, such as a ring structure, to achieve scalability with resilience to network churn and node flux. Auxiliary structures such as contraction hierarchies may be used to augment and optimize performance of basic DHT operations, including put and get operations. Other approaches may be based on trees, including distributed spanning trees and forests. The trees may be primitive structures that enable and support graph and simplicial algorithms. The trees may be constructed using purely distributed protocols and algorithms in a self-organizing approach from unconnected graphs of the CPs.

The trees may be used for construction and operation of the CP networks. In particular, distributed minimal spanning trees (MST) may be constructed to connect the CPs and may minimize a cost associated to edges in the CP connection graph. A CP connected by a distributed MST may be the root of its own MST. Multiple distributed MSTs may be constructed of the CPs, where one or more of the distributed MSTs may minimize a different cost associated with the CP connection graph. The multiple distributed MSTs may be interleaved to construct a high-performance, flexible, and resilient overlay mesh network of the CPs.

Computation of a distributed MST may be achieved using various known algorithms, such as the GHS algorithm. The GHS algorithm may build components of a distributed MST in levels. The GHS algorithm may be augmented using a number of known protocols for peer addition, fault recovery, and incremental improvement of the MST. Known heuristics may be used to bound the MST degree and diameter. The complexity of the GHS algorithm may be reduced by granting one or more nodes knowledge of their components during execution of the algorithm. Nodes may report a list of their children to the component root. A resulting list may then be broadcast in a subsequent search phase.

Another method of complexity reduction may use Bloom filters to provide approximate or partial knowledge of the components rather than broadcasting an entire list of component membership. In addition to methods based on the GHS algorithm, a distributed MST may be constructed using algorithms based on Kuskal's algorithm, such as the distributed edge-partitioning and vertex-partitioning algorithms. A distributed MST may also be constructed using algorithms based on Prim's algorithm, such as the parallel Prim's algorithm. Algorithms such as the parallel Prim's algorithm may be augmented by use of a Fibonacci heap to store or structure intermediate results of computed connection components.

A purely distributed algorithm for construction of minimal spanning trees may be implemented if a cyber-physical system includes a number of CPs in an initially unconnected graph. A CP may be assigned a unique ID. The CPs may be initially unconnected and in a sleeping state. The CPs may wake from their sleeping states on their own or in response to an external stimulus, such as a beacon request from a neighboring CP. Upon waking, a CP may transition into a finding state. The CP may generate a beacon request to neighboring CPs. The beacon request may contain the CP's ID as well as a record of its local channel set (LCS). The LCS may be the set of potential communication channels sensed locally by the CP which may be associated with a cost or weight. The cost or weight may measure channel signal strength and may be stored along with associated information in a record or table.

If a CP receives a beacon request while sleeping, it may change its state to finding and generate its own beacon request containing its own ID and LCS. Upon receiving a beacon request, a CP may generate an acknowledgement reply that may contain its own ID and LCS. Upon receiving an acknowledgement reply, a CP may transition to a found state and begin construction of a common control channel (CCC) set. The CCC set may be a local MST component or fragment of the connection subgraph of the CP LCS. A CP may begin construction of the CCC by comparing its own LCS to the sender's LCS.

If a destination node is included in only one of the two LCS, then a channel from that LCS may be associated to the CCC. If the destination node is present in both LCS, then a minimum cost channel in the LCS may be associated to the CCC. Determination of a minimum cost channel among the LCS may be achieved using known minimization or reduction methods, which may involve single-machine MST algorithms on a local connection subgraph formed by the LCS.

For a destination node, the CCC with minimal cost may be referred to as a branch and may be associated to the CCC set. Second best channels and next-best channels may be saved as temporary branches for potential use in the case of main-branch failure. Channels that are not next best may be saved as rejected. The CP may generate an update message that includes its ID and the CCC fragment and may send the update message to one or more neighbors from whom it received an acknowledgment reply. The CP may change its state to found. Upon receiving an update message, the CP may compare its own CCC and the senders CCC. The CP may construct the optimal CCC that connects a destination node in its own fragment and the sender's respective fragment. As before, second best channels may be set as temporary branches, and channels that are not second best may be set as rejected.

The optimal CCC edges constructed from the LCS connection graph may be set as the branch optimum. Upon receiving update messages and constructing the optimal CCC with respect to the LCS of one or more of its neighbors within a given timeout period, a CP may broadcast a minimal tree topology message to its neighbors, The minimal tree topology message may include the CP's ID and the optimal CCC. Upon receiving a minimal tree topology message from all neighbors, or upon exhaustion of a timeout period, the CP component edges may be set as the branch optimum, the state of the CP may be set to locked, and the algorithm may terminate.

A set of distributed MSTs that connect the CPs may be constructed using a distributed k-MST algorithm. The distributed k-MST algorithm may be considered as k instances of a distributed MST algorithm and may generate k forests of trees of the CP. The distributed k-MST algorithm may compute the k MST concurrently. At a time point during execution of the algorithm, a CP may have membership in k trees. A CP may keep an additional internal state with respect to each of the trees and may append additional information as necessary to messages sent.

The k forests output by the distributed k-MST algorithm may be used in conjunction with a link state protocol to construct overlay meshes upon the physical network of CPs. The link state may be used to compute robust and adaptive overlay paths through the k forests for flexible path selection. Known algorithms such as Djikstra's algorithm and the Bellmann-Ford algorithm may be used to compute optimal paths through the overlay mesh. The paths may optimize any of the cost metrics minimized by the MST. For example, the distributed k-MST may include MSTs that maximize bandwidth or signal flow, minimize latency, or minimize packet loss. Optimal paths with respect to any of these metrics may be computed from the overlay mesh constructed using the k-MST. A self-organizing network generation process may support dynamic optimization of signal flow channels for communication. The overlay mesh network may be a robust, resilient, flexible, scalable, and efficient fabric for communication between CPs included in a CPS.

Communication over channels in the overlay mesh network of distributed k-MST may support distributed execution of an application-level program. Execution of the program may achieve implementation of a system of COMs by the CPS. As aforementioned, the Ptides model of computation may be used for programming of the CPS. In order for the cyber-physical system to operate semantically based on a Ptides model of a system of COM, bounds may need to be obtained as described above. More specifically, bounds of clock synchronization error and network latency may be required due to fundamental differences between the synchronous and reactive model of a system of COMs and the system when realized in practice.

Unlike the synchronous and reactive model of a system of COM, OMs in a system of COMs implemented by a cyber-physical system may evolve at different fundamental rates. An OM may be associated with a clock that measures time in proportion to the fundamental rate of evolution of the OM. In order to enable comparison of values of time in a way that preserves the aforementioned desired properties for a semantic notion of time, a global or system clock may be established relative to which the procession of time by each individual clock may be measured.

Establishment of a global clock in a system of COMs may be achieved by implementation of a clock synchronization protocol across CPs in a cyber-physical system implementing the COM. A CP in the system may be associated with a clock, which may be a pure signal with well-defined period. Messages sent by the CPs may be marked by a stamp of the local platform time. The CPs may synchronize their clocks in a precision time protocol (PTP) by execution of a clock synchronization algorithm, such as the best master clock (BMC) algorithm. By using a PTP and bounded loop microprocessors, bounds may be obtained on the clock synchronization error, as well as the network latency over communication channels across the CPS.

An OM may be embedded in the physical plant connected to a CP via sensors and actuators. For example, a traditional one channel transducer may be used to sample, modulate, sense, and actuate the value of a quantity at a point in the physical environment. For example, the value may be the pressure in a physical acoustic medium such as air. In such a case, the quantity evolving over time may be treated as the sound field potential of a zero-dimensional OM (i.e., as a function of time at a point). In another example, a two-dimensional array of transducers may form a net or surface. The surface may be in the shape of a region of a plane, or a sphere, and may be used to sample and modulate the values of a quantity over a set of components in the physical environment. The values may be treated as values of the sound field potential over a submanifold section of the surface of a two-dimensional OM having the corresponding shape. Thus, in addition to implementation of an OM as a cyber process evolving in a closed feedback-control loop, a CP may also implement coupling of a cyber OM with a physical OM. This may be done by sampling and modulation of the sound field potential of the physical OM using a transducer complex embedded on its surface.

Thus the cyber-physical system for implementation of a system of COMs may be composed of one or more OMs implemented locally by CPs that are connected to one another via the network fabric and to one or more OMs in the physical world via arrays or complexes of transducers. Operational semantics expressed using the Ptides modeling paradigm may be used for distributed execution of synchronous and reactive composition and coupling of the OMs and formation of a system of COM. A “safe to process analysis” parameterized by the known bounds on clock synchronization error and network latency may be used to ensure deterministic behavior of the CPS.

In the Ptides model of a system of COM, the rates of evolution of OMs in the physical world may be treated as evolving according to idealized Newtonian time. In other words, the OMs may evolve at the same fundamental rate. The tolerance of the rate of evolution may be equal to the clock synchronization error bound. On the cyber side of the model, a CP may be endowed with a clock that is synchronized (with bounded error) with all other clocks in the system. When a sensor coupled to a CP takes a measurement, the measurement may become an event with a time stamp equal to the local platform time. To produce a reaction by an actuator coupled to a CP, a time-stamped message may be delivered to the actuator. The time stamp may be interpreted as a deadline of when the reaction is to occur with respect to the local platform time. The actuator may then immediately react, or it may delay reaction until the local platform time is equal to the time stamp value.

Computation and network communication may occur between the sensing and actuating that is monitored and controlled by the CPs. Message payloads transmitted through the network may be bundled together with time stamps. An event that is produced by a sensor connected to a CP and processed by a computation on the platform may have its time stamp increased by a logical time delay. The event with the increased time stamp may then be passed to a network transmitter port. As with a message delivered to an actuator, the time stamp of an event delivered to a network transmitter port may be treated as a deadline. The transmitter may send the message before the deadline or delay transmission until the deadline.

If a CP receives multiple streams of time stamped events, the events may need to be processed in time-stamp order. If multiple events share the same time stamp, then a computational process in the platform may need to see the events simultaneously. In order to accomplish this, the Ptides “safe-to-process” analysis may be used to ensure that before an event with a given time stamp produced by one of the streams is processed, no other event produced by another of the streams will produce an event with time stamp equal to or less than “t”. The “safe-to-process” analysis may leverage the known bounds on clock synchronization error (“e”) and network latency (“d”). Specifically, it may be safe to process an event with time stamp t by a computation on the platform after a time equal to the sum of the values t, e, and d.

Safe execution of the computational process may produce an event having the original time stamp. Having waited to process the event safely, the local platform time may exceed the value of time in the original stamp by at least the sum of e and d. To account for this, the time stamp of the event at the computation output may be modified by a logical delay greater than the sum of d and e. However, while it may be necessary for the logical time delay to be greater than the sum of the bounds on network latency and clock synchronization error, it may not be sufficient. Although the “safe-to-process” analysis may ensure that a sequence of time-stamped events produced at the system sensors will result in a unique well-defined sequence of time-stamped events at the system actuators, it may not guarantee that events are delivered to the actuators before the time-stamp deadlines.

In order to ensure timely execution of a sequence of events, it may be possible to determine a schedule of the firing of components such that the event deadlines are met by a given execution engine. In general, determination of such a schedule may require bounding the execution time of software components in the engine. In order to increase the ability for a wide range of physical realizations to implement the deterministic cyber-physical system model of a system of COM, various methods for optimization and compression over the network may be used. Specifically, techniques for compression of the signals sent over the network fabric between CPs in the cyber-physical system may be effectively used to increase the scheduleability of the system over various systems.

During distributed execution of a system of COMs by a CPS, the primary content of signals transmitted over the network between CPs may be an encoding of rain. Other content of the transmitted signals may include a specification of group actions, such as rotational, translational, and scaling information. The transmitted signals may also include general orbital actions that may be performed on interfaces of rain and the spatial arrangement of components therein. The signals may also include a specification of general actions and database operations that may be performed on the underlying simplicial structures of OMs and may affect the OM geometry and shape. These actions and operations may be executed by the cyber-physical system in a separate operational mode, in series or parallel with the above mentioned operational semantics, and may be described in additional detail below. Compared to the pulse field information encoded by the rain, the complexity of the specification of the group actions and operations on simplices may be relatively lightweight.

In the case where group actions are applied to a domain over which a rain is being sampled, a record may be constructed in the form of a list mapping the sequence of actions to the corresponding time-stamps or indices at which they occurred. The list mapping the actions applied to the sampling domain onto the samples obtained over the corresponding intervals of time may be formed alongside the rain during the sampling process. This list may be bundled together with the rain for emission, and used to decode the rain after reattachment for absorption. For example, a rain may be sampled over a disk submanifold domain on the surface of a spherical OM. The disk may expand at a uniform radial rate over the surface of the sphere as the rain is sampled. Subsequent sampled sections of the rain may be conformally mapped to a canonical domain of disk topology, and the sequence of regular cross sections thus formed may constitute the main informational content carried by the emitted rain. A sequence of incremental scaling actions applied to the domain over which the rain was sampled during the rain formation process may be reapplied, if applicable, to perform an analogous sequence of scaling actions on the submanifold domain over the target OM on which the rain is absorbed. For example, in the above example, if the target domain of absorption is also a disk submanifold on a spherical OM, then the rain may be absorbed over a disk that is also expanding at a uniform radial rate over the surface of the sphere.

A rain emitted from one OM and absorbed by another OM may entail a relatively large amount of information to be encoded, decoded, and processed by the CPs. It may reduce the scheduleability of the evolution of a system of COMs if the conformal or harmonic maps used to align pulse fields emitted from one OM and absorbed by another OM are performed at high frequency. Reduction of the number of discrete events included in the rain signal may improve the system evolution scheduleability and may reduce the number of conformal or harmonic maps necessary to perform. In the following description, efficient methods for harmonic and conformal mapping are discussed, as well as a method for compression of rain. In addition to reducing inessential network flow, in the context of applications, compressive modeling and distillation of OM vibration may improve the quality of sounds propagated by and transmitted through the system.

As described above, a pair of scalar fields, each parameterized by a simplicial surface, may be aligned using a harmonic or conformal map. Various methods may be used for computation of the discrete maps, including methods based on weighted Laplace-Beltrami eigenprojection, least squares conformal maps (LSCM), spectral conformal parameterization (SCP), discrete Ricci flow (DRF), angle based flattening (ABF), circle patterns (CP), conformal equivalence of triangle meshes (CETM), and boundary first flattening (BFF). Boundary-controlled conformal mapping of simplicial surfaces with disk topology to Euclidean target geometries may be achieved using the BFF algorithm. Boundary-free conformal mapping may be achieved using SPC. Mapping to non-Euclidean coordinates, such as spherical target geometries, may be achieved using methods based on DRF.

Harmonic mapping may be achieved using a discrete Laplace-Beltrami operator for simplicial surfaces and energy minimization. In particular, a procedure for harmonic mapping of functions parameterized by simplicial surfaces may include the following steps. The manifold boundary may be traced and a sequence of boundary vertices may be obtained. The image of the mapping for a boundary vertex may be set using a specialized boundary function. For an edge of the manifold, the cotangent edge weight may be computed using the known cotangent formula. For all interior vertices of the manifold, the discrete Laplace equation may be constructed using the cotangent weights. A linear system of equations may be formed, which may then be solved using a common linear solver to achieve the harmonic map.

A method for aligning functions on simplicial surfaces of disk or genus-zero topology using conformal mapping between the surfaces may be described below. Alignment of functions on higher-genus manifolds may be achieved by first performing topological reduction of the manifolds to disk topology via methods for manifold cutting. A procedure for alignment may then be performed. If the function on a surface is to be mutated by combination with the other, as in a symmetric interaction, then boundary-free conformal mapping of the surfaces to a canonical domain may be performed. For example, boundary-free conformal mapping to a disk or sphere may be performed using SPC or BFF.

If only a function on one of the surfaces is to be affected by addition of the other to it, then a conformal flattening of that surface may be performed via SPC or BFF. A boundary-controlled conformal mapping or harmonic mapping of the other surface onto the domain of the former may then be performed.

After the surfaces are aligned via initial maps to a common domain, data from the functions on the respective surfaces may be compared. When a function of a first surface is to be mutated by combination with a function of a second surface, an inverse of the initial map of the second surface may be used. In other words, the function of the first surface may be taken to the domain of the second surface by composition of the initial map of the first surface with the inverse of the initial map of the second surface. After the functions on the simplicial surfaces are aligned with one another, the functions may be prepared for combination.

For transmission of rain between OMs, the mapping techniques may be used as follows. When a rain forms in the ambient space of an OM from which it will be emitted, or in an interval of time after formation before emission, the sequence of spatial parameterizations of vibratory information encoded in the rain may be conformally or harmonically mapped to a canonical domain. The canonical domain may be compatible with the target domain of absorption if the target domain is known. The rain may then be transmitted from the source OM to the target OM. When the rain arrives in the receptive ambient space of the target OM, the inverse process described above may take place. The sequence of instances of the canonical domain that parameterize the vibratory information encoded in the rain may be mapped to the surface domain of the target OM. The rain may then be absorbed by the target OM.

Subsets of the sequence of instances of the canonical domain that parameterize the vibratory information encoded in the rain may also be mapped to the surface domain of the target OM and absorbed as available. This may enable staggered decoding and absorption.

Thus, rain emitted from a source OM and absorbed by a target OM may pass via a composition of maps through one or many of the various canonical domains of uniformization. It may still be necessary, for scheduleability of the model of a system of COMs described above on many execution engines or systems for physical realization, to reduce the frequency with which the mappings are performed. A method may be used for compression of rain and reduction of the number of the discrete events of which it is composed.

Techniques for signal processing, harmonic analysis and sinusoidal modeling of audio may be used to encode and decode rain in a way that distills the salient informative components of the rain and compresses its overall complexity. Whereas a rain as described above may be composed of a sequence of pulse fields, or sound field pulses, a rain may also be represented as a sequence of sound field spectral peaks. Spectral analysis and processing of a rain, useful for its compression and quality feature distillation, may be achieved by use of an elementary sinusoidal modeling technique based on tracking of spectral peaks in a short-time Fourier transform (STFT).

A stream of pulses obtained by sampling of a sound field potential at a point on the surface of an OM may be stored in a sliding buffer, such as a circular buffer. The stream of pulses may be transformed using a STFT, which may operate using a fast Fourier transform (FFT). The STFT may have a specified frame size, window type, FFT size, and hop size. The window function may be chosen to be one of a number of possibilities, such as the Gaussian, Hamming, Hanning, or Blackman windows.

The FFT buffer filled by the input signal may be of a size greater than the specified window frame. The space remaining in the buffer from the difference in size may be padded with zeros. More specifically, zero-phase zero padding may be used, wherein data framed by an odd-length window may be centered about the origin in time.

The squared magnitude spectrum, measured in decibels, may then be obtained from the results of performing the FFT on the windowed data. The bin numbers corresponding to the peaks in the spectrum may then be obtained by locating maxima in the spectrum. For a peak estimate, a parabolic interpolator defined by three spectral samples, in decibels, may be used to refine estimate of the location of a peak. The three spectral samples may include the local maximum of the peak and a spectral sample on either side of it.

The magnitude and phase of a peak may then be calculated from the maximum of the parabola defined by the three spectral samples. The parabola may be evaluated separately over the real and imaginary parts of the spectrum to obtain the complex spectrum. A peak with a magnitude above a specified threshold may then be assigned to a frequency track, or oscillator, using a scheme for matching and tracking peaks across sequences of adjacent frames in the STFT. This may be done by matching peaks of a previous frame with those of the current frame.

More specifically, at a frame, an oscillator may search for a peak that is closest in frequency to its current frequency. The difference in frequency may be less than a specified maximum delta. The difference may be a frequency-dependent limit, such as a linearly varying limit, that may correspond to a relative frequency change limit.

If a match for the track is found within the maximum limit for difference in frequency, then the track may be continued. A conflict may occur if a track finds a match that has already been claimed by another track. If a conflict occurs the track may be continued or it may be stopped.

If no match for the track is made, it may be assumed that the track should “turn off” as it enters the current frame. The current frequency of the track may be matched to itself with an amplitude equal to zero. The amplitude of the terminating track may be linearly ramped to zero over the duration of a frame hop. The track may remain at zero amplitude. If at a future frame, the track finds a spectral peak within its delta capture range, it may turn back on, match with the peak, and ramp its amplitude to the detected value.

If a track finds a match but has a conflict with another track, the peak may be given to the track which is closest in frequency to the peak. The losing track may look for another match. If a track loses a conflict, it may pick the best available non-conflicting peak. If a track wins a conflict, it may call the peak assignment procedure recursively on the dislodged track. If the dislodged track finds the same peak to claim, it may continue searching. This matching process may be repeated for one or more of the tracks and conflicts between claims of spectral peaks by different tracks may be resolved recursively. The matching process may continue until all tracks are matched or turned off.

After the one or more tracks have been extended forward in time into the current frame, the peaks of the current frame that have not been used may be considered as new trajectories. New tracks may be started for the unused peaks using up to a specified maximum number of oscillators. The specified maximum number of oscillators may be less than the number of spectral peaks detected. The new oscillator tracks may be started up at zero magnitude and may ramp to the correct amplitude at the current frame.

The tracks may be started, turned off, or turned on at a given frame by interpolation of the track amplitude to or from zero. A hysteresis law may govern the reactivity with which the tracks change state. For additive resynthesis, a sinusoidal wave may be generated for one or more of the frequency tracks and the one or more waves may be summed into an output buffer. The instantaneous amplitude, frequency, and phase for the one or more sinusoidal waves may be obtained by interpolating the corresponding values between frames. Linear interpolation may be used to obtain the instantaneous amplitude. The instantaneous phase may be obtained by use of a cubic polynomial as the interpolation function. The coefficients of the squared and cubic terms in the cubic polynomial may be calculated by the end conditions at the track frame boundaries. Accordingly, a set of interpolating functions that depend on the window size may be obtained. A maximal smooth function may be chosen from the set of interpolating functions. The length of the output buffer into which the signal is resynthesized may be equal to the hop size of the STFT. The hop size may be chosen as a fraction of the window length.

Elementary sinusoidal modeling of a streaming rain signal may be performed over a variety of spatial domains. For example, instead of the one dimensional Fourier transform, the two dimensional Fourier transform may be used to process signals over a surface with a flat metric. Spherical harmonics may be used to process signals over a spherical surface. More generally, a method analogous to the method for spectral peak matching described above may be used for processing of signals in the sound field over the curved surfaces of an OM by using a transform over charts on the surface. A spectrum of the signal may be obtained via decomposition of the eigenspectrum of the Laplacian over the surface.

Accordingly, rain emitted from a source OM to a target OM may be compressed. The salient musical characteristic of the rain may be distilled before transmission over the network fabric. A rain compressed as described above may be composed of a sequence of windowed sound field spectra. The techniques described above for compression of rain may support minimization of inessential signal flow over the cyber-physical system while maintaining transmission of the most salient musical information between OMs connected in the CPS.

If a rain is not in signal format compatible with a target OM, the rain signal may be resynthesized as described above. The resynthesized rain may appear in the ambient space of the target OM and may be absorbed. Temporal and spectral transformations may be used to convert between different rates of evolution of OMs as a rain is transmitted. The transformations may be performed using parameter modifications to the oscillator tracks before resynthesis as described above. A standard sampling rate conversion, such as a sample rate conversion based on the band limited sinc interpolation method, may also be used to speed up or slow down a rain for emission or absorption. For example, a rain may be emitted from a source OM and may absorbed by a target OM evolving at a fundamental rate equal to twice that of the first. The rain may be upsampled or downsampled upon appearance in the receptive ambient space of the target OM. Alternatively, the rain may also fall with a velocity proportional to the ratio of the fundamental rates of evolution of the OM.

During the absorption and modulation of an OM's sound field potential by a rain, modulation of the components of the submanifold sections over which components of the rain are absorbed may be blurred or smoothed. This may mitigate proliferation of numerical artifacts due to discontinuity caused in the sound field potential. For example, the amplitude imparted by a pulse in a stream of pulses absorbed by an OM may be spread using a Gaussian window locally over the region of impact. The effective radius of the Gaussian window may be set as proportional to the amplitude of the pulse. This spatial smoothing technique may be applied generally using other window types. It may also be used with absorption of other components of rain, such as curves and sheets.

To manage computational resources expended locally by a cyber-physical system implementing a system of COMs, rules may also be applied to the harmonic resolution with which sound fields are compressed, distilled, analyzed, and resynthesized. Specifically, the number of time-varying oscillator tracks used in analysis or resynthesis of a sound field may be determined by a function of the extended specific harmonicity of the sound. This may allow for the flow of sound in the form of rain between COMs to be assigned to a number of oscillators for use in its representation. The number of oscillators may represent the rain as a function of its destructive or constructive interference with fields of sound on the COMs.

The number of oscillators used for the representation, analysis, and resynthesis of sounds may be finite given finite computational resources available locally to a CP. In general, a CP included in the cyber-physical system may be equipped for analysis and resynthesis of sound as described above using a finite number of time-varying oscillators. The number of oscillators may be bounded by the hardware capacity of the CP as well as by scheduleability requirements of the system.

The time-varying oscillators available to a given CP may be used for representation of the flow of sound between OMs implemented locally by the CP and other OMs coupled to the locally implemented OMs. The oscillators may be used for analysis of sound propagating on the local OM. The oscillators may encode the sound propagating on the local OM into compressed rains that may then be emitted to non-local OMs. The oscillators may also be used for resynthesis of sound decoded from compressed rain emitted from the non-local OMs and absorbed by the local OM.

The time-varying oscillators may be used as a fluid computational resource that may be shared and dynamically allocated amongst multiple CPs implementing a system of COMs. Various methods may be used for compression and analysis or resynthesis of sound using a set of time-varying oscillators distributed among multiple CPs connected via the network fabric.

A sound propagating on an OM implemented locally by a CP may be represented and sampled by a number of satellite CPs connected to one another via the cyber-physical system network fabric. This distributed representation may be achieved by partitioning or sharding the spectrum of the sound and assigning analysis or resynthesis of the various partitioned spectral sections to the local oscillator pools of the satellite CPs. Any number of redundant representations of partitions of the spectrum may be replicated across the time-varying oscillators of any number of the CPs.

A CP assigned a task of analysis or resynthesis of a spectral section of the sound may utilize its own time-varying oscillator to track peaks in the sound occurring in that part of the spectrum. To converge or recombine the various partial instances of the time-varying sound spectrum for resynthesis, which may be received as a rain, a CP may recall the results of sectional spectral peak matching from the satellite CPs. The results may be collated and the rain may be resynthesized. Methods based on the machinery of sheaves may be used to achieve the collation.

As described above, a database may be used to organize and store tables of information including computational results for any and all of aforementioned operations or constructions. Tables within the database may correspond to simplices of the database schema, and may be manipulated via tiles. The tiles may be given as simplices of the schema, and the tables may be manipulated via the tiles that represent their corresponding simplices. Custom databases may be assembled by mixing and matching tiles, and tiles may be added to an existing database to create a new one.

Various kinds of graphical manipulations of tiles may facilitate flexible design of ODSs. In an example, drag-and-drop gluing of tiles may enable formation of ODS schema via patchwork composition. Two tiles that share a common face A may be connected together along A by taking the limit of a diagram in the category of simplicial databases. The specific table along which the simplices are joined may be a universal table, or it may be a more controlled table. In the case of a more controlled joining, the tiles may have additional markings on their A-faces to indicate compatibility of data types. These markings may indicate the specific table along which the join takes place.

In another example, tiles and schema corresponding to incoming or outgoing rains of specified length may also be dragged and dropped on underlying schema of an ODS. If a rain stored over a tile that is dropped on the underlying schema of an ODS is incoming, it may subsequently be absorbed. If the rain is outgoing, it may be emitted or its emission may be delayed and it may serve as a receptacle of length n that may store sound field data over the submanifold domain of the ODS. Tables over rain interface domain manifolds may accumulate sound field values over subsequent ticks of the clock cycle of the ODS, and may build up rain data which may begin to be absorbed or be subsequently and instantaneously emitted upon command. If a rain is dropped onto the schema of an ODS over which there is already a rain being stored, various operations on the rains may be presented as options and selected. For example the dropped rain may replace the existing rains, or the rains may be concatenated, multiplied, and convolved.

In another example, the tiles connected in a schema may represent a variety of fundamental filters. The filters may be applied to sound field data stored over a schema. For example, an attenuation filter may be applied that may multiply the sound field defined over a vertex by another number. In this case, there may be a table in the simplicial database with two columns, one representing a sound field and the other representing an attenuation coefficient. A multiplication tile may be attached by connecting its operands edge to the edge in the database schema representing the two columns. The attenuation operation may then be performed by drawing a curve through the operands edge and ending at the product vertex of the multiplication tile. Schema composed of tiles of this sort connected together may be used to implement spatial smoothing filters or to boost signals as they propagate over ODSs.

Tiles may also be attached that may affect the length of table columns corresponding to simplices in the underlying schema of an OM modeling an ODS. The tables may store historical data of the ODS sound field changing through time, and may thus function as memory receptacles for rains over the ODS. Variation in the length of the tables over the ODS may represent variation in memory capacity for the rains. The length of a column table corresponding to a vertex in the underlying schema of an OM modeling an ODS may be changed from length n to length m. This may induce a change in type of propagation that the ODS implements, namely the ODS may change from being an n-historical propagator at that vertex to an m-historical propagator at the vertex.

In another example, graphical manipulation of tiles may correspond to the specification of simplicial submanifolds that may act as coupling interfaces of rain between ODS for conformal or harmonic mapping between emission and absorption domains of the rain. This manipulation may be accomplished graphically using the following process.

A path may be drawn in the underlying schema of an OM modeling an ODS that encircles a connected component of the surface. The interior of the component may be specified. The encirclement and interior specification process may be repeated for each of any additional connected components, forming a connected or disconnected emission domain manifold. If a user interface device with multiple gestemic drivers is used (e.g., a touch-sensor pad), then specification of the domain components may be executed in parallel. Once specification of the domain components is complete, an option to terminate specification of the emission domain may be selected. The same process may then be used to specify the domain manifold of absorption.

For example, given an ODS having the shape of a sphere, the form of a rain between two submanifolds of disk topology on the surface of the sphere may be established by first drawing a circle on the sphere then clicking on a point not on the circle to specify the interior of the emission domain manifold. The emission domain manifold may then be specified and another circle may be drawn on the sphere. The process may be repeated to specify the absorption domain manifold in the same way.

Once the domain manifolds have been specified, a schema representing the particular desired mapping operation for compatible domains may be selected from a list of available harmonic or conformal maps. The emission domain schema may be dragged and dropped onto the mapping schema, which may trigger execution of a uniformization procedure and return a regularized rain. The rain may be fed to another schema, representing the inverse mapping, along with the absorption domain schema. The process of inverse mapping may be executed and a rain that is compatible over the absorption domain manifold may be returned as the result.

In another example of graphical manipulation, a wave odometer may be used for path length measurement. The wave odometer may calibrate, adjust, or regulate the placement of emission and absorption interfaces for time delay and amplitude attenuation of waves propagating between them in design of a sound field. This may be accomplished as described below.

A map M may be considered as the schema for a simplicial database having simplices that may have dimension 0 or 1. The vertices of M may be seen as the intersections of wave transport channels and the 1-simplices may be seen as the portions between these intersections. Each portion may have a measurement of distance, d, which may be recorded as an integer, floating point number, etc. Over each portion or wave transport channel connecting two vertices there may be a table with two columns. The table of all pairs of integers s may be t, where t−s may be equal to d. As with tables for basic mathematical operations such as addition, this table may be assumed to exist in fullness but be implemented as a virtual table, and only an appropriate finite portion of it may be shown.

The simplicial database may include a 1-column table T of wave odometer readings, which may be a subtable of the 1-column table over any intersection A of the map. A user of the system may draw a route through the map from A to another intersection, B. Using the above techniques, this may result in a functor from tables over A to tables over B. Applying this functor to T may result in a table over B whose entries are the integers, or floating point numbers, etc., corresponding to the new odometer readings given for a journey of a wave that is absorbed at A and propagates with a fixed wave speed to B. Using this method to query the path distances between points, a user may calibrate, adjust, and regulate the placement, velocity, and amplitudinal effect of emission and absorption domain manifolds on an ODS. For example, given coefficients of dampening, wave speed, and spectral dispersion, it may be computed that a specified waveform may propagate over a maximum distance before a given frequency component or band of the wave is attenuated beyond recoverability. If the waveform is to be absorbed at A and reemitted at B, and if it is required that the frequency component of the waveform be preserved during propagation over a specific path connecting the domains, such as to pass a secure message, the above methods may be used for querying path distances. If the distance between the emission and absorption domains is found to be in excess of the maximum allowed distance (beyond which a message may be irrecoverable), the emission or absorption domains may be moved over the ODS so as to be closer to each other.

The cyber-physical system may operate or be operated in one or more different modes. In one mode, the sound field data on the OM may be visually exposed and changing. The sound field data may be graphically represented over the surface of the OM using a mapping to assign colors to points or components of the surface, which may then be rendered as collections of pixels on a screen. Operation in this mode may include an example where a user directly manually inputs a stream of sound (e.g., data) to an OM. The coupling relation between the source of user input and the OM may already be specified, such that only the value of the sound field data on the OM changes. The user may change the data on the surface of the OM (i.e., the sound in the sound field), but not the underlying geometry and shape of the OM (i.e., the sound field) itself.

Another mode may be one in which the underlying simplicial structure of the OM is exposed to the user for direct control and editing. The user may operate upon the underlying simplicial structure of the OM by manipulation of mesh or table structures. Visually, these two modes may correspond to either seeing the oscillating height fields on the OM, or not seeing the sound field data and instead just seeing the underlying simplicial (triangulated) surfaces of the OM, exposed for manipulation.

Clear delineation between operation of the system in these two modes may be accomplished via a number of methods for customized graphical rendering. For example, a rendering of the height field may be given a degree of translucency, which when set to zero may show the height field in maximum clarity, and when set to full may hide the height field from view and instead expose the underlying mesh. A user may optionally instruct the system to show a wire-frame rendering of the surface, which may show only vertices and edges of the underlying mesh. If operation on higher-dimensional simplices is required, then the simplices may be shaded corresponding to the order of their dimension. For example, 2-simplices may be lightly shaded, and simplices of the maximum dimension of the complex implemented by the mesh may be darkly shaded. This may enable the user to visually distinguish components of the mesh geometry and operate upon them as needed.

In other words, in the first mode of operation, the sound field data may be exposed for control. In another mode, the sound field data may be hidden and the data structure may be exposed. These two aspects may be bundled together due to the nature of the two-part, cyclic process of OM evolution involving the Laplacian and AFEM. A change in the underlying structure of a sound field may result in changes to the sound field over time. Likewise, a perturbation applied to the sound field may result (via resimplexification) in changes to the geometry of the sound field.

A schema may represent the shape of and type of table corresponding to an ODS, but it may not have data in it. In sound-field rendering mode, the zero-level set data of an ODS may be visualized as the height field representing the ODS sound field. In editing or mesh-manipulation mode, the height field may be hidden from view. In order to see the table corresponding to an ODS a user may click on a simplex in the underlying mesh of an OM modeling the ODS. If a user clicks on the mesh of an OM modeling the ODS, the view of the corresponding table consequently provided to the user may show one or many scrolling streams of values representing the sound field of the ODS at the current time. For example, at each simplex in the OM modeling the ODS, the value of the sound field at the current time may be represented by a field of scalar values. These fields of values may appear to change in time synchronously with the evolution of the ODS as the user views the table.

The table may also record the sound field values stored over longer periods of time than the interval between ticks of a global clock during evolution of an ODS. The value of the sound field over each simplex in a mesh may be recorded at a number of discrete steps occurring over a finite interval (t,t+n) of the evolution time t. A table corresponding to a simplex in the mesh of an OM modeling the ODS may store sound field data of length n in n rows. New sound field data may automatically be pushed onto the top of the table, and old sound field data may be automatically removed as the ODS evolves and data is streamed through the table. In this way, the table may act as a type of window or memory of the sound field data. If the length of the table is increased, such as by the user graphical manipulation, the sound field values of any added rows may be implicitly set to zero, and be automatically replaced with new values as data streams through the table over time. A user may directly extend or reduce the length of any number of columns in a table that records sound data of an ODS, for example, by clicking on the column layout bottom boundary and dragging down in a workspace environment. In this way the user may directly manipulate at a high level the length of memory allocated to store the sound field data of different ODS. This may facilitate the storage and construction of PFM signals or rains over the ODS.

During operation of the system in editing mode, automatic adaptive resimplexification or refinement of meshes may optionally be turned off, or the frequency with which it is performed relative to the ODS rate of evolution may be reduced, in order to allow for a controlled user editing environment of the ODS geometry and shape. In addition, the rate of evolution of the cyber, or discrete, ODS may be controlled, and in particular may be slowed down or stopped, to enable controlled editing. Editing of mesh states may be carried out in a version controlled repository of the simplicial database. Edited states may be split from, substituted in, or merged with extant mesh states, and may be discarded, duplicated, etc.

As described above, the cyber-physical system may be used for SDL of sound. The cyber-physical system may be used for other purposes, such as live communication, collaboration of music and speech, gaming, and for localization of sound in space and time. Usage of the cyber-physical system for these purposes may be supported by a number of augmenting auxiliary features. More specifically, a graphical view of the system may be rendered using standard methods known in the art of graphics, image and video processing.

When one or more of the OMs in a cyber-physical system are rendered for a camera or observer, a viewpoint may be situated at some height above the surface in its ambient space. A fish-eye or hyperbolic projection of the surface onto the viewpoint may be used. The color of the surface itself may also be rendered in a way that represents the musical information encoded therein. Specifically, logarithmic, linear or polynomial interpolation may be used to assign a color to each point on the surface. A map between the ratio of the value of the sound field potential, the range of admissible values at that location, and a component of a color space such as the HSV color space may be used to assign colors.

The graphical view of an OM may be a view of the OM sound field evolving over its underlying simplicial surface. Another graphical view may also be used for operation of the cyber-physical system in a different mode, in which the sound field or height field of the OM may not be rendered or exposed. Instead, the underlying simplicial mesh structure of the OM may be displayed and exposed for the user to control. This graphical view may facilitate manipulation of the mesh structures underlying the OM sound field data. A user of the cyber-physical system may toggle between these modes of operation and control both the structure of the sound fields and the sound field data contained thereupon.

As described above a graphical language for table manipulation in the simplicial database may be implemented. Users may manipulate and query underlying mesh data structures, which may include querying sound field data records, and may perform operations on the mesh structure such as joining two meshes together at a simplex, duplicating, deleting, or projecting a mesh, etc.

With access to the underlying mesh of an OM, a user may query sound field history (i.e., rain data). For example, a user may specify an action to build up a rain over a domain on an OM by accessing the mesh data under that domain and creating a buffer or receptacle in which the rain may be stored. Instructions for this action may be specified by the user via higher level or gestural programming. The user may, for example, specify the spatial extent of the domain and a time interval over which the rain is to be measured and recorded. The rains may be graphically rendered and exposed along with the sound field data during operation of the cyber-physical system in a data-view mode, as opposed to a structure-view mode.

Another auxiliary feature of the cyber-physical system that may relate to security of propagation and transmission of sounds across the system components. Traditional methods for cryptography may be used to transmit information between CPs. More specifically, CPs in the cyber-physical system may establish and maintain security of communication channels between one another using security, authentication, integrity, and confidentiality parameters. Secure channels for communication connecting subnetworks of the CP may be achieved using one or more cryptographic methods. Symmetric, asymmetric, and/or hybrid protocols and algorithms may be used, and may involve use of one or more of the advanced encryption standard (AES), the XOR-dual RSA algorithm, and elliptic curve cryptography (ECC).

Hybrid methods may involve an initial exchange, via a transport layer security (TLS) handshake, of a private key via asymmetric cryptographic methods. The private key may then enable subsequent use of more efficient and scalable symmetric cryptographic schemes. Methods for message integrity assurance may involve cryptographic hashing techniques, such as the MD5 algorithm. Hashing may be used to generate a unique fixed-length signature for the message. Algorithms such as the two-phase hybrid cryptography algorithm (THCA) may combine the above methods to provide high levels of security for communications between the CPs.

The usage of absorbing and transparent boundaries, as described above, may provide a method for securing information flow in the CPS. The flow of sound over a communication channel between a pair of COMs may or may not be secured from other OMs coupled to either of the two COMs participating in the communication. Without an absorbing boundary preventing subsequent propagation of sound transmitted via emission and absorption of a rain between the communicating COMs, the transmitted sound may naturally propagate upon the OMs in the pair on which it is absorbed and eventually to other OMs sampling sound field potentials. This may result the other OMs hearing the content of the communication. Constructing absorbing boundaries on the surfaces of OMs included in systems of COMs, particularly between the coupling interfaces of OMs in the system, may enable curatorial and architectural control over the various paths for communication possible between different regions of the vibrating surfaces. The definition of boundary conditions on OM may be carried out in conjunction with the graphical language for table manipulation in the simplicial database while the cyber-physical system is operated live in the aforementioned editing mode. In an example, the boundary conditions may be defined by drawing, along the simplicial surface (e.g., with a cursor or pad) the path along which one wants to define the boundary and selecting from various boundary types from records available at the start and end vertices.

Although not limited to the following, the methods and systems described above may be used as a musical instrument for synthesis and analysis of live sound fields, a platform for musical gaming, and a cyber-physical environment for live musical communication, coordination and collaboration.

In an example, a cyber-physical system may be used as a musical instrument. The cyber-physical system may consist of a single CP that is connected to one or more sensors and one or more actuators. The one or more sensors may include a one-dimensional pressure sensor that may map an input range of scalar values to an output range of the same. The one-dimensional pressure sensor may represent time at a point or a normalized unit of area in space.

The one or more sensors may be a pressure sensitive pad upon which a human user may manually press to generate values in a range of scalar values. The one or more actuators may be a one-dimensional actuator such as a conventional loudspeaker. The one-dimensional actuator may represent time at a point or a normalized unit of area in space. The CP may be coupled to the one or more sensors. The CP may execute evolutions of an OM, which may be an open one-dimensional OM or a bounded string OM.

Other methods for direct ‘manual’ control of the sound field of OM may be used. For example, a conventional brain computer interface (BCI) may be used. The BCI may include one or more electrical components arranged in a circuit that may be used to measure a quantity of electrical charge or current flowing through a neural circuit, pathway, or tract. The measured quantity may be represented as a scalar value at a point or as a spatially parameterized field of scalar values. In an example, the BCI may include an actuator dial.

Variation of the field may represent variation about an equilibrium of the quantity of charge or current. This may be similar to how a pressure sensitive pad may be used to measure a quantity of pressure, where the quantity of pressure may similarly be represented using a scalar field and variation of the field may similarly represent variation about an equilibrium of the pressure.

The BCI may include a transducer that subsumes the functionality of the sensor and actuator into a single device. The interface for measurement and control of electrical charge or current in the neural circuit, pathway, or tract may provide extended manual support to a human user of the cyber-physical system in a manner analogous to an interface utilizing pressure sensitive pads. A user may directly control (e.g., monitor, measure, and generate) one or many streams or rains of PFM, such as a time-varying function at a point, by manually varying the current in a channel or tract or the voltage at a terminal.

An example of a signal that may be manually varied by a human user to directly process sound in a cyber-physical system implementing an ODS may be the users pulse. The pulse may be measured, for example by using a pulsometer using electrocardiographic or photoplethysmographic techniques. The instantaneous frequency of the pulse may be measured. The rate of the pulse may be represented as a spectrum, with higher order partials in the spectrum representing micro-fluctuations in the pulse rate, and the pulse signal corresponding to the spectrum may be emitted as a rain from an ODS corresponding to the transducer interface attached to the users body.

If the pressure sensitive pad is being used, a user of the system may generate input directly to the system by manually displacing the pad from equilibrium pressure. For example, the user may create a sinusoidal displacement wave over the unit area of the pad by undulating pressure placed on the pad. The user may press the pad in below an equilibrium and the pad may rise to a value above the equilibrium. The equilibrium position may be calibrated and adjusted. By using the pad, the user may exert direct manual control over the amplitude and phase of the generated wave.

The physical domain of the one or more sensors may be mapped to a domain on the surface of the OM. A coupling interface on the surface of the OM may be in motion. The coupling interface may be controlled automatically, such as by as a function of the gradient flow of the sound field potential. The coupling interface may be controlled directly by an auxiliary input from the one or more sensors or another controller. The coupling interface may be directly controlled by specifying vectors in the tangent space of the domain on the surface of the OM and interpolating motion over sequences of frames in a denoted direction. The coupling interface may be controlled by a set of customized axiomatic gestural inputs that may denote group actions on the interface and may be used to construct sequences of orbital motions of the interface.

The physical domain of the actuator may also be mapped to a domain on the surface of the OM. Signal input from the one or more sensors may be treated as a rain composed of pure streams of raindrops over of the individual sensors. The input may be a stream in which a raindrop is either present or not present at an instant. The value of the stream may be zero when a raindrop is not present. The rain may be processed and emitted to the OM as described above. The rain may be resynthesized in the ambient space of the OM. The rain may fall upon the OM over the specified coupling interface and it may be absorbed. Likewise, a rain may be periodically sampled and output to the actuator. The sampled rain may drive the vibration of an acoustic medium in the physical world to which the array is coupled. More specifically, a user may synthesize physical sound at the point source actuator by generating manual displacement of the input sensors in the form of the sound wave.

The OM executed by the CP may have spatial extent whereas the one or more sensors and one or more actuators connected to the CP may not. A cyber-physical system may also consist of a single CP that is connected to one or more sensors with spatial extent. A cyber-physical system that consists of a CP equipped with one or more sensors and a point actuator that executes evolution of a spatially extended OM may support multiple-input single-output (MISO) processing. The one or more sensors may be a regular or irregular grid (e.g., a simplicial complex) of one-dimensional pressure sensors. The one-dimensional pressure sensors may measure a value a field (e.g., pressure or temperature) over time at a point in space or of normalized unit of area in space. The one-dimensional sensors may be a linear or circular array of point-sensors. In the linear or circular array of point-sensors, each sensor may be measure a value of a field (e.g., pressure or temperature) over time at a point in space or of normalized unit of area in space. Alternatively, the linear or circular array of point-sensors may collectively act as a single point-sensor (e.g., by averaging input values) that measures a value of a field (e.g., pressure or temperature) over time in a spatially extended domain. Linear and circular sensor/actuator arrays may also be used as input and output mechanisms connected to a CP. In another example, a two-dimensional array of point pressure sensors may be used.

The CP may execute evolution of an OM, which may be in the shape of a sphere. The physical domain of the one or more sensors may be mapped to a domain with disk or spherical topology on the surface of the OM. The coupling interface on the surface of the OM may be in motion.

The physical domain of the point actuator, or single actuator without spatial extent, may be mapped to a point domain on the surface of the OM. The coupling interface may move on the surface of the OM. In an example of MISO processing, a user may generate multiple manual displacement waveforms on the one or more sensors. Signal inputs from the one or more sensors may be treated as a rain composed of pure sequences of raindrops, strings, and sheets. The rain may fall on the OM over the specified coupling interface where it may be absorbed. Absorption of the rain may modulate vibration of the OM and cause waves to propagate on the surface of the OM as it evolves. As the waves from the multiple inputs propagate over the domain on the surface of the OM to which the physical domain of the single actuator is mapped, the waves may superimpose over the domain and may be sampled to form a signal that may be output to the actuator. In this way, multiple inputs may be combined to synthesize a single output signal.

A cyber-physical system may also consist of a single CP that is connected to a single sensor without spatial extent and to one or more actuators. The sensor may be a one-dimensional pressure sensor. The one or more actuators may be an array of loudspeakers in the shape of a sphere. The CP may execute evolution of an OM in the shape of a sphere. The physical domain of the sensor may be mapped to a point domain on the surface of the OM. The physical domain of the spherical actuator array may be mapped to the entire surface of the OM.

A user may synthesize arbitrary sound at the point domain to which the sensor is mapped on the surface of the OM by generating manual displacement of the sensor in the shape of the sound wave. Signals input from the sensor may be treated as a rain composed of a pure stream of raindrops. The rain may fall upon the OM over the specified coupling interface where it may be absorbed. Absorption of the rain may modulate vibration of the OM and cause waves to propagate on the surface of the OM as it evolves. As the waves propagate over domains on the surface of the OM to which the physical domain of an actuator in the actuator array is mapped, the wave may be sampled to form a signal which may be output to the actuator. In this way a single input may be used to synthesize multiple output signals as a single input multiple output (SIMO) system.

A cyber-physical system may also consist of a single CP that is connected to one or more sensors and one or more actuators. The sensors may be used to generate input to any number of the actuators. The CP may execute evolution of an OM in the shape of a sphere. The one or more sensors may be a spherical array of one-dimensional pressure sensors. The one or more actuators may be a spherical array of one-dimensional loudspeakers. The domains of the one or more sensors and the one or more actuators may be mapped to domains covering the entire surface of the OM.

A user may synthesize sound by generating manual displacement of the one or more sensors. The user may use multiple fingers to draw multiple sinusoidal waves that may be spatially distributed and have potentially different amplitude, frequency, and phase simultaneously. Signals input from the one or more sensors may be treated as rains composed of pure sequences of raindrops, strings, and sheets of rain. The rain may fall upon the OM over the specified coupling interface, where it may be absorbed. Absorption of the rain may modulate vibration of the OM and cause waves to propagate on the surface of the OM as it evolves. Waves from multiple sources of sound may propagate over domains on the surface of the OM to which the physical domains of an actuator in the one or more actuators are mapped. The waves may be sampled to form a signal which may be output to the one or more actuators. In this way, multiple inputs may be used to synthesize multiple output signals in a multiple input multiple output (MIMO) system. As described above, the cyber-physical system may be used in editing (i.e., construction) mode to craft or design the surfaces themselves via direct mesh manipulation. This may be supported by a live editing mode graphical view.

For example, a user of the system in live editing mode may drag and drop simplices of an individual surface and select from a list of options to glue the simplices together. This may be used to change the surface topology by creating a path on a surface between points that were previously not path connected or connecting two initially disjoint neighborhoods of points.

The cyber-physical system may be used as an instrument by multiple users. The multiple users may control input to the cyber-physical system and may monitor output from the cyber-physical system via multiple sensors and actuators. The sensors and actuators may sample or perturb one or many instances of OMs, which may be distributed over any type of physical environment. The use of the cyber-physical system as an instrument may also be extended to multiple OMs implemented as cyber processes by CPs connected via the network fabric in the CPS.

As shown in FIGS. 3 and 4, the cyber-physical system may include systems of COMs. Couplings formed between instances of OMs in the cyber-physical system may provide extended manual support for users to directly synthesize sound fields by generating manual displacement of sensors mapped to mobile domains on the surfaces of the OMs. The scope with which users may be able both to synthesize and to sample sound fields over the surfaces of the OMs may increase with the spatial extent, resolution, and the number of couplings of the system.

A system of OMs, in which the OMs may be coupled or disjoint, may be considered an individual exterior OM. The sound field of the exterior OM may be defined piecewise, and the Laplacian may act locally over the interior component OM. Properties of the OMs interior to the composition, such as determinism may be preserved under assembly, and the composite exterior OM may inherit the properties. The dynamics of the exterior OM may be determined precisely by the specific combination of cascade and side-by-side or patchwork type compositions amongst the interior OMs. Each interior OM may propagate sound and the exterior OM may be a propagator at a higher level.

Similarly, a network of CPs implementing a system of OMs may be considered an individual CP. The network of CPs may be composed of smaller CPs, and the entire composition may have a nested structure. The network of CPs may be recursively built up from smaller networks. The process of assembly may continue perpetually, subject to constraints on resources. Certain CPs in a nested network of CPs may be identified as atomic, or prime. The atomic CPs may be at the lowest level of a hierarchy of the CP.

The evolution of an OM may be classified into a variety of modes. For example, an OM with surface velocity zero everywhere or everywhere oscillating around a noise floor may be referred to as a quiescent OM. An OM that undergoes an amplitude death may be identified as being in quiescent mode. The sound field of a quiescent cyber OM may be extended into the future without computation of the Laplacian over its surface, which may enable energy saving. The evolution rate of an OM with surface velocity converging to quiescence may transition to or from an arbitrarily small positive quantity over one or many ticks of a global clock.

Similarly, a CP executing implementations of an OM may have a variety of communicative modes corresponding to the OM evolution that may determine the inputs and outputs of the CP. The CP may repeatedly update its communicative mode. For example, a CP implementing a quiescent OM may have only an input port for listening. In another example, a CP may have only an output ports and no input ports. A set of CPs may be arranged into an aggregate, and the aggregate itself may be a higher-level CP having its own set of communicative modes that may determine its input and output ports and the way it may connect with other CP in its environment.

Information may flow through a nested mode-dependent network Y of CPs as follows. First, each inner CP may convert its state to an output. The outputs of the inner CPs, together with the input to network Y, may be carried through the network communication channels and either exported from network Y or fed as inputs to the inner CPs. The inner CPs may then use the input to update their state, their communicative mode, their own shape, and the shape of the entire CP network Y.

For gaming uses, various rules may be applied to the cyber-physical system to enable user interaction. For example, one or more rules may control the growth and decay of the coupling interfaces. These may include speed of motion, size, dampening, resolution, or amplitudinal effect of the coupling interfaces. Growth of a coupling interface may correspond to the sound field spectrum having high harmonicity. The value used to determine growth or decay may be obtained using an extension of the specific harmonicity formula, taking into account the amplitudes of spectral components. First, all inaudible frequencies in the spectrum may be excluded. The specific harmonicity of the remaining spectrum may be computed. The individual inharmonicities of each intrascalar interval may be multiplied by the reciprocal of the square root of the product of the amplitudes of the pair of frequencies forming the interval. Complex behaviors may arise from this simple rule governing growth and decay of coupling with the various fields of sound.

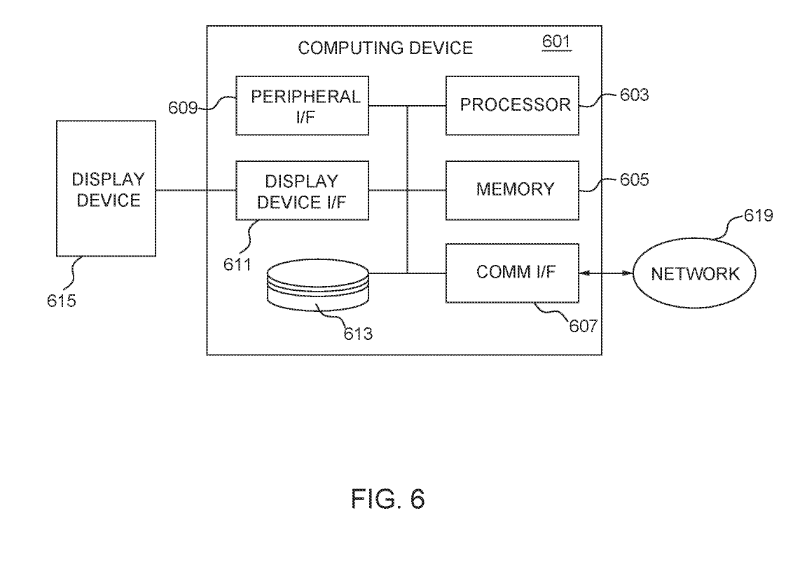

Referring now to FIG. 6, an example computing device that may be used as a CP 601 is shown. The CP 601 may be implemented in the clients described below. The CP 601 may include a processor 603, a memory device 605, a communication interface 607, a peripheral device interface 609, a display device interface 611, and a storage device 613. FIG. 6 also shows a display device 615, which may be coupled to or included within the CP 601.

The memory device 605 may be or include a device such as a Dynamic Random Access Memory (D-RAM), Static RAM (S-RAM), or other RAM or a flash memory. The storage device 613 may be or include a hard disk, a magneto-optical medium, an optical medium such as a CD-ROM, a digital versatile disk (DVDs), or Blu-Ray disc (BD), or other type of device for electronic data storage.

The communication interface 607 may be, for example, a communications port, a wired transceiver, a wireless transceiver, and/or a network card. The communication interface 607 may be capable of communicating with a network 619 using technologies such as Ethernet, fiber optics, microwave, xDSL (Digital Subscriber Line), Wireless Local Area Network (WLAN) technology, wireless cellular technology, and/or any other appropriate technology.

The peripheral device interface 609 may be an interface configured to communicate with one or more peripheral devices. The peripheral device interface 609 may operate using a technology such as Universal Serial Bus (USB), PS/2, Bluetooth, infrared, serial port, parallel port, and/or other appropriate technology. The peripheral device interface 609 may, for example, receive input data from an input device such as a keyboard, a mouse, a trackball, a touch screen, a touch pad, a stylus pad, and/or other device. Alternatively or additionally, the peripheral device interface 609 may communicate output data to a printer that is attached to the CP 601 via the peripheral device interface 609.

The display device interface 611 may be an interface configured to communicate data to display device 615. The display device 615 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 611 may operate using technology such as Video Graphics Array (VGA), Super VGA (S-VGA), Digital Visual Interface (DVI), High-Definition Multimedia Interface (HDMI), or other appropriate technology.

The display device interface 611 may communicate display data from the processor 603 to the display device 615 for display by the display device 615. As shown in FIG. 6, the display device 615 may be external to the CP 601, and coupled to the CP 601 via the display device interface 611. Alternatively, the display device 615 may be included in the CP 601.

An instance of the CP 601 of FIG. 6 may be configured to perform any feature or any combination of features described above. For example, the CP 601 may be coupled to one or more sensors and/or one or more actuators described above through the peripheral device interface 609. The one or more sensors and/or one or more actuators may detect general vibratory information, including physical vibrations and/or digital geometric vibrations propagating in acoustic media. In such an instance, the memory device 605 and/or the storage device 613 may store instructions which, when executed by the processor 603, cause the processor 603 to perform any feature or any combination of features described above. Alternatively or additionally, in such an instance, one or more of the features described above may be performed by the processor 603 in conjunction with the memory device 605, communication interface 607, peripheral device interface 609, display device interface 611, and/or storage device 613.

Although FIG. 6 shows that the CP 601 includes a single processor 603, single memory device 605, single communication interface 607, single peripheral device interface 609, single display device interface 611, and single storage device 613, the computing device may include multiples of each or any combination of these components 603, 605, 607, 609, 611, 613, and may be configured to perform, mutatis mutandis, analogous functionality to that described above.

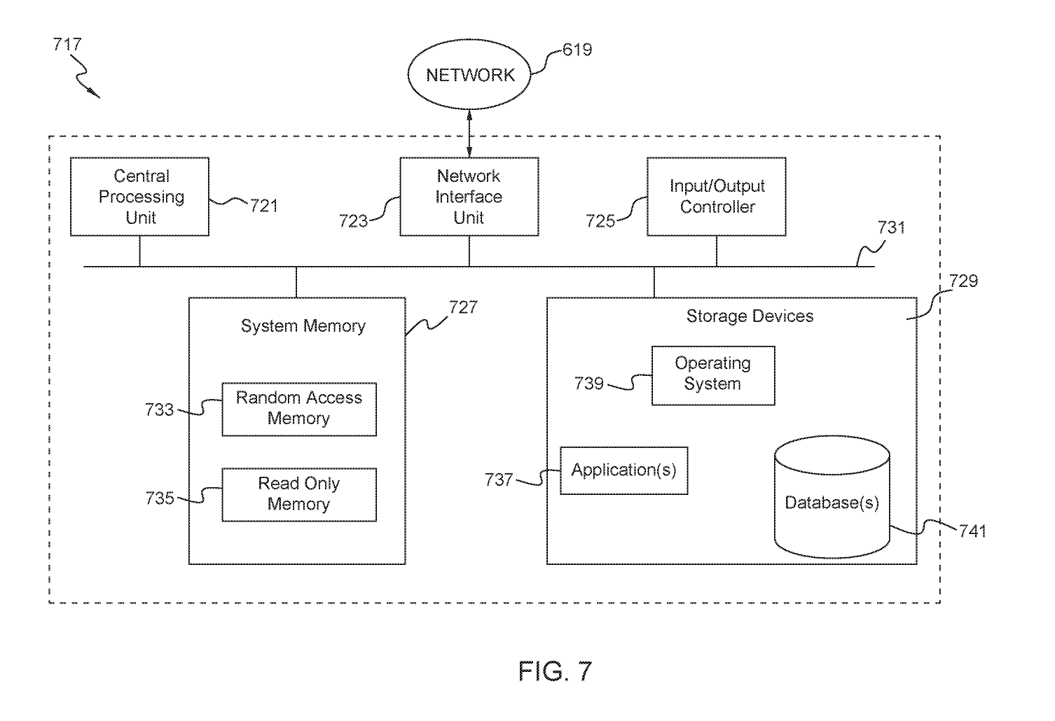

Referring now to FIG. 7, a component diagram of a server 717 that may be used as in the cyber-physical system is shown. The server 717 may be a conventional stand-alone web server, a server system, a computing cluster, or any combination thereof. The server 717 may include a server rack, a data warehouse, network, or cloud type storage facility or mechanism that is in communication with the network 519. The server 717 may include one or more central processing units (CPU) 721, network interface units 723, input/output controllers 725, system memories 727, and storage devices 729. The CPU 721, network interface unit 723, input/output controller 725, system memory 727, and storage devices 729 may be communicatively coupled via a bus 731.

The system memory 727 may include random access memory (RAM) 733, read only memory (ROM) 735, and one or more cache. The storage devices 729 may include one or more applications 737, an operating system 739, and one or more databases 741. The one or more databases 741 may include a relational database management system managed by Structured Query Language (SQL). The storage devices 729 may take the form of, but are not limited to, a diskette, hard drive, CD-ROM, thumb drive, hard file, or a Redundant Array of Independent Disks (RAID).

The server 717 may be accessed by one or more CPs 601 via the network 519 using a mainframe, thin client, personal computer, mobile device, pad computer, or the like. Information processed by the CPU 721 and/or operated upon or stored on the storage devices 729 and/or in the system memory 727 may be displayed to a client through a user device.

The server 717 may leverage a Service Oriented Architecture (SOA). For example, when a CP 601 invokes a function, such as actuation in an acoustic medium, that function may be performed within the CP 601 or it may be redirected to the server 717. This redirection may be performed by a service bus that exposes a set of service endpoints to CPs 701 that interact with these services as if the services were local. The service bus may direct requests for those services to the appropriate service providers either locally or in the network 619 based on configured mapping. Mapping may be done on a per service basis, allowing a mix of local and cloud-based services to be used. The service bus itself may be local or may be located in the network 619. The disclosed systems and methods may be designed for multitenancy, such that many entities may share the same physical database resources but may keep their respective data entirely private.

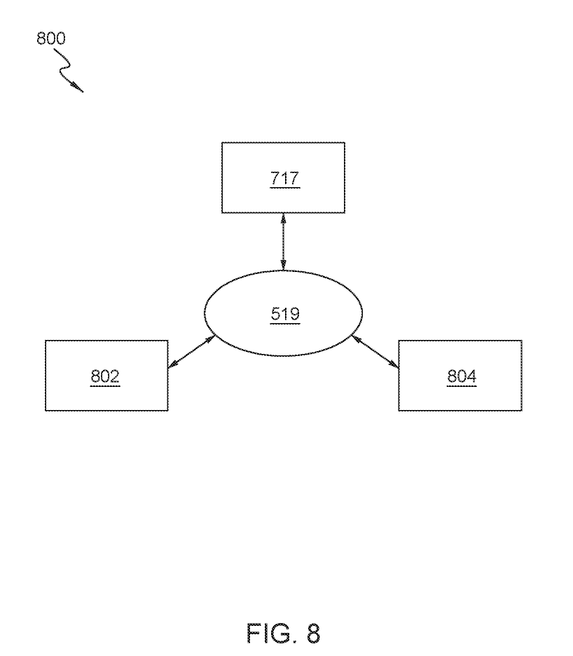

Referring now to FIG. 8, a diagram illustrating a cyber-physical system 800 using a Ptides model as described above is shown. The cyber-physical system 800 may include a first CP 802 connected to a second CP 804 through the network 619. The server 717 may also be connected to the network 619 and may provide one or more services to the first CP 802 and the second CP 804. As described above, the first CP 802 and the second CP 804 may include one or more sensors to receive a physical or programmed input and/or one or more actuators to provide a physical or displayed output. In an example, the first CP 802 may be ion a first physical environment and the second CP 804 may be in a second physical environment.

The first CP 802 may interact with the second CP 804 via a flow of sound that may be sensed, using one or more of hardware and audio driver software, from the first physical environment. The sound may be formatted and packaged as a generalized stream by the first CP 802 and transmitted over the network 619 to the second CP 804. The second CP 804 may unpack and decode the stream for rendering. The second CP 804 may actuate the sound into the second physical environment using one or more of audio driver software and hardware.

Using the system of COMs 300 describe above with reference to FIG. 3 as an example, the 0-OM 302 may represent a sound field that is being captured by a physical microphone in the first physical environment. The 1-OM 304 may represent a sound field that is being sampled and actuated by an array of transducers in the first physical environment. The first CP 802 may sample data from the 0-OM 304 microphone over some interval of time and store samples collected over that interval. The samples may be time-stamped and ordered (e.g., in chronological order), which may result in a signal in the form of a rain. The first CP 802 may potentially perform sample rate conversion and filtering, and may apply a logical time delay.

The first CP 802 may specify an attachment map onto the 1-OM 304, which may correspond to picking a point. The first CP 802 may transmit the signal as a rain, with all of the relevant information such as the specified attachment map bundled together, over the network 619 so that it reaches the controller of the 1-OM 304. In an example, the simulation of the 1-OM 304 may be hosted by the server 717 (e.g., as an extension of the first CP 802 controlling the line array of transducers) or it may be hosted locally by the first CP 802. The rain may be received by the 1-OM 304 and imparted to its surface at the specified location. The 1-OM 304 may be mapped to the array of transducers, and modulation sampled over its surface may be upsampled and emitted to and absorbed by the transducer array. Thus, when the modulation coming from the microphone of the 0-OM 302 is imparted to the 1-OM 304, the result may be to cause an actuation of physical sound by the array of transducers. The sound coming from the microphone of the 0-OM 302 may not just play out of one speaker in the array of transducers, but may propagate and diffuse over all the transducers in the array, with appropriate time delay and attenuation.

The second CP 804 may have access to the 1-OM 304 and may control an actuation of physical sound by a corresponding array of transducers in the second physical environment. Additionally, or alternatively, the second CP 804 may perform any of the methods described above to process and map the rain from the 0-OM 304 to any dimension OM for actuation in the second physical environment. Additionally or alternatively, the second CP 804 may control one or more OMs connected to the 1-OM 304 in a patchwork of COMs and may receive the propagated sound.

The server 717 may provide the first CP 802 and the second CP 804, and any number of additional CPs, access to one or more OMs to design and redesign as described above and one another through the network 619. The server 717 and associated process may be accessible at a specified domain name and address to CPs via a conventional connection over the network 619. The CPs may be able to send and receive messages from the server 717. A CP may request service access from the server 717 and may thereupon be associated with a unique ID and identified as a user on the platform of services by the server 717.

The user may be provided by the server 717 with an option to purchase a variety of services, such as connection to a live sound field event, or computational resources on which to run a time-delimited process whereby the user may obtain a live evolving OM modeling a dynamical surface of their own. In another case, a user may purchase the ability to store an encoding of a sound field as a record contained in the server 717 database, and the encoding may be associated with the unique ID of the user. The encoding may be stored in a variety of file formats, but may generally consist of an underlying mesh, or schema, as well as a sound field potential, or more generally a rain field, defined over that schema or over a sequence of schemas which may represent the deformation of a single schema through time. Each user may have a library of sound fields, or encodings of dynamical surfaces modeled as one or more OMs or COMs, and these libraries may be stored on the server 717. Access to a library of sound fields on the server 717 may be provided to a user on demand.

Users may discover and connect with each other over the network 619 using a variety of media sites for social interaction and live sound propagation. For example, there may be a publicly available domain sound field that may be perpetually evolving and computed by the server 717. Users may be able to join this sound field as listeners, or speakers, or both for a nominal fee. This may be as simple as a user issuing a request to the server 717 to join the sound field, and the server 717 identifying the user with a location on the dynamical surface implementing the sound field. The user may specify a location or a location may automatically (e.g., randomly) chosen by the server 717. The user may move around the dynamical surface via simple transport over the surface, and may instruct the execution of said motion (e.g., by actuating specified key events that may be mapped to conventional coordinate transformations). The key events may be registered on a CP operated by the user and a record of the key events may be transmitted over the network 619 to the server 717. By moving over the surface, a user may discover new parts of the sound field and interact with other users in the different parts.

There may be one or more available sound field surfaces or domains, each of which may be identified as an individual realm, locale, or region that may or may not have a corresponding location in nominal physical space. In addition to the publicly or semipublicly available sound fields, there may be private sound fields that individual users or groups of users may obtain access to, and for which the access of others to may be restricted, monitored and controlled. In an example, a private musical event happening in the physical world may be streamed online to an extended private audience by creating a dynamical surface which may be coupled with the physical sound field of the corresponding musical event through one or more CPs. The dynamical surface may be evolved on the server 717 in synchrony with the live event. Access to the live cyber sound field may be granted to users, for example, upon payment of a fee.

Various methods may be used for display of, and navigation through, the set of publicly or privately available sound field domains hosted by the server 717. In particular, a discovery map may be openly displayed to users whereby the users may view the various domains as icons in a planar or higher dimensional representation. The icons representing the domains may be labeled with the domain names and with labels denoting the level of restrictedness of access to each domain. A variety of methods may be used for generation and arrangement of discovery maps. For example, in the case where geographical information pertaining to the location of users or of cyber sound fields coupled to physical sounds fields is available, the icons symbolizing the sound fields may be attributed with locations in, for example, planar coordinates, and may be arranged in a graph and presented for view in a manner that reflects the geographical information.

In another example, an arbitrary distance metric may be assigned to a space, and locations of users may be assigned randomly or by use of a specialized procedure. In another type of example, the metric corresponding to each minimal spanning tree in an underlying network may induce a discovery map. Icons on the map may be grouped more closely as a function of the length of the shortest path between them. In another example, a k-means clustering algorithm may be used to partition a collection of sites over an underlying metric into a Voronoi diagram that may intuitively reflect relative distances between regions of users.

Each user in a collection may opt into a mesh generation process, whereupon each user may be assigned a coordinate location (e.g., at random) in a planar or higher dimensional region. The Delaunay triangulation of the set of locations may be taken, and the resulting triangulation may be a mesh associated to each vertex of which there may be a corresponding user. Each user may then declare a value to be assigned as the potential of the mesh at the site identified as their location, or the initial sound field potential may be randomly generated, selected automatically, or selected by user instruction from a preset library of field potentials. The users may then optionally operate upon the mesh in a mesh design stage, wherein the users may add or delete vertices, refine or coarsen simplices in the mesh, and connect or disconnect simplices of the mesh together. These manipulations upon the mesh may be carried out using the graphical language for manipulation of the schema of a simplicial database described above, Tiles, or simplices of the mesh may be added, and paths through the mesh may be drawn to indicate queries and to issue commands for the execution of procedures for mesh manipulation, such as procedures to compute the intersection or union of two components of the mesh. Once the mesh has been generated, its evolution may be initiated and continue perpetually until an instruction is issued for the evolution to cease, or until resources that have been provisioned for its computation have been expended.

Graphical rendering of both dynamical surfaces, as well as of auxiliary facilities and features such as mesh discovery maps may be carried out on a CP using native support for graphical rendering.

Sonic environments and fields wherein sources of sound may not propagate spherically or radially with equal energy in all directions, but rather in a directed manner may be modeled. A region in which the primary energy of the sound source is focused may be approximately delimited by the use of cones, wherein absorbing boundaries may be established and used to implement the boundaries of cones in the model. For example, it may be desirable to model a sonic environment in which a group of human speakers are oriented towards one another and conversing. The sources of sound emitted by each of the speakers in the conversation may not propagate with equal energy radially, but rather may propagate out such that the bulk of the energy is focused in an approximately conical shape. In order to model this using a numerical scheme, an absorbing boundary condition in the shape of a cone may be established that may envelope the sound of each speaker. The cone may contain the speaker sound source in its convex interior cavity and may absorb any waves that propagate out except in the directions delimited by the cone. This may be used, for example, to allow one user to speak with increased privacy to another user in an otherwise open environment. The cones may be widened or narrowed to adjust the spread of sound propagation, and may be turned on or off. The cones may be rotated or swung around, which may enable modeling of conversational environments in which human interlocutors may turn in different directions and speak in those directions. Multiple cones may be used to delimit a sound radiation pattern with multiple conical sections. The cones may also be used for the dual purpose of controlled listening (i.e., to delimit the incident sound field that is heard over a component enveloped by the cone) and to filter out incoming sound propagating from other directions. The usage of cones in these ways may be a special case of controlling sound propagation on a dynamical surface by defining absorbing boundaries thereupon.

Two physical sound fields may be superimposed or adjoined via a mediating cyber-physical connection medium. In a simple case, there may be two disconnected physical spaces, and in each space there may be a connected region triangulated by an array of transducers (e.g., speakers or microphones. By identifying components of the two disjoint transducer arrays with the same simplices of a mesh underlying a dynamical surface, the evolution of which may be being computed in synchrony with the propagation of sounds in the two physical spaces, sounds from each physical sound field may flow naturally and continually into the other. This may, for example, be used to adjoin or overlay the sound fields of disparate disjoint physical events, such as musical performances or spoken conversations, and extend the ability of participants of those events to communicate with each other and socialize.

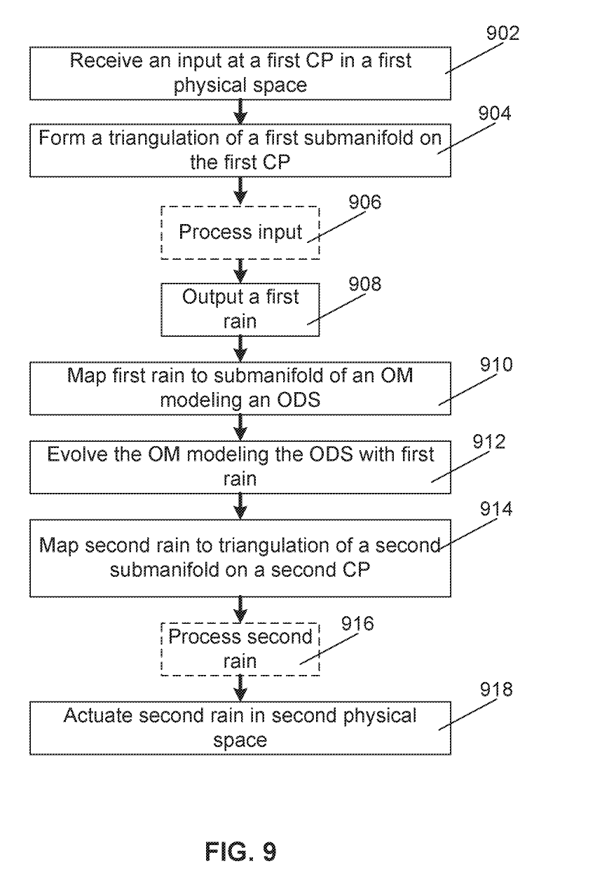

Referring now to FIG. 9, a flowchart illustrating a synchronous distributed localization of sound in a cyber-physical system is shown. In step 902, a first CP may receive an input. As described above, the input may be from one or more sensors that record scalar values, such as pressure sensitive pad, CBI, or a pulsometer. In another example, the input may be from one or more transducers located in a first physical space.

The input may be a signal of time-varying sound field potential data sensed recorded by one or more sensors, such as microphones. The one or more sensors may be distributed in the first physical space. The one or more sensors may be equipped with a topology in which two actuators may be connected if they are in the same general space, or if measurable sound may propagate from one to the other. Distances between the sensors may be given by a metric on the space. In an example, the sensors may be in motion during the interval of sensing, whereupon the relative distances between the sensors may be measured via time-of-flight measurements. A record of the distances may be updated dynamically, using I/O controllers to send and receive the measurements and ancillary processing units to incorporate the various measurements into a metric for the collection.

In step 904, the input may be used to form a triangulation of a first submanifold modeling the first physical space. The triangulation may constitute a time-varying spatial parameterization of the velocity field of the sound received by the one or more sensors. It may be this object over which the sound from the first physical space is sensed.

The one or more sensors may or may not be equipped with a topological and/or geometric structure. In an example, structure may be derived or constructed from available information. In another example, there may be no structure information. If the one or more sensors have no structure (i.e., the one or more sensors are not connected and no metric information is given on the first physical space), the first CP may receive a stream of PFM from each sensor. If each sensor is a point, then the first CP may receive a set of streams of PCM.

Generally, the one or more sensors may be equipped with the geometric structure of a simplicial complex. Thus the set of sensors together with its structure may be referred to as a sensor complex, and a set of sensors and actuators together may be referred to as a sensor complex. The parametric spatial domain of a rain formed by inputs received from such a complex may be given by all or part of the (time-varying or static) geometric structure on the set of sensors.

Each sensor in the one or more sensors may have a corresponding location in the first physical space given by a metric. A tessellation of the one or more sensors may then be formed using the locations (e.g., by use of a method for construction of a Delauney triangulation). In another example, an arbitrary distance metric may be used. Various methods may be known for taking a set of disconnected points (point cloud) with distances in a metric space and forming a tessellation of the points. Different methods may have different properties and may preserve different structures. Constructing a Delauney triangulation may be a sufficient, but not necessary, for constructing sound field structure that preserves intrinsic sonic semantics of the sound field.

The one or more sensors may come pre-equipped with a structure. For example, the one or more sensors may come equipped with a nearest-neighbor topology that may be based on geophysical locations. In another example, wired or wireless connections between the one or more sensors may be directly reflected in the structure, such that sensor devices which are directly wired together or between which exist direct wireless connections may be identified as neighboring.

When the one or more sensors is referred to as a sensor array, or more generally as a transducer complex, it may be understood that discrete topological and geometric structure of the one or more sensors is available to the first CP, and this structure may be represented via a mesh.

In optional step 906, the input may be processed by application of a transformation. In the simplest case, the transformation may be the identity, in which case the signal may be output unchanged. In general, the transformation may involve applying a sample rate conversion to the signal, such as by use of band-limited sinc interpolation, as well as applying filtering, amplification or attenuation to specify frequency components in the spectrum, such as by use of a partial tracking and time-frequency distribution processing method. As described above, methods such as peak-matching, which may be used for the processing of time-frequency distributions, may be defined over domains that are spaces endowed with a Euclidean metric. These methods may be generalize to other settings, such as the setting of two-dimensional manifolds, by working with the spectrum of the Laplace-Beltrami operator.

In practice, it may be common to downsample the signal, in particular when the signal is originally sampled by microphones or other sensors that may be operating and sampling at an extremely high rate appropriate to the fine-grained dynamics of sound in physical acoustic media. This step may also be used to filter out any noise that may be present in the signal. In an example, a head-related transfer function (HRTF) may be used to transform raw signals to recreate intra-aural time differences.

In step 908, the CP may output a first rain. The first rain may include the triangulation of the first submanifold as well as the sound field potential/data defined over that triangulated manifold. The first CP may sample a physical sound field domain of the first physical space using the one or more sensors and may construct a summary of the sampled data as the first rain which may be parameterized over a simplicial complex. The first rain may include, as part of its informational content, a spatial parameterization of the sound data. The first rain may be a simplicial manifold that may be changing or deforming through an interval of time, and which may represent the geometric and/or topological structure of the one or more sensors used for sensing. The first rain may include a sequence of one or more regular pulse fields.

In step 910, the first rain may be mapped via a structure-preserving attaching map (e.g., a harmonic or conformal map) or via a composition of such maps to a submanifold section on the surface of an OM. The OM may be modeling an ODS. The result of this step may be a generalized stream or rain of PFM suspended over the surface of the OM ready for absorption. As described above, the sequence of simplicial manifolds (representing a single simplicial manifold evolving through time) parameterizing a rain may be mapped all at once. This may be effective, for example, when the manifold does not change as it evolves in time, (e.g., if the one or more sensors used for the sensing are stationary). Alternatively, the sequence of simplicial manifolds may be mapped in succession, for example, as they are available or in a way that may optimally distribute the computation given available resources.

In step 912, the attached first rain may cause the OM modeling the ODS to evolve according to an inhomogeneous acoustic wave equation. The first rain may be absorbed by the OM modeling the ODS over an interval of time, during which interval the OM modeling the ODS may also vibrate and propagate sounds on its surface. As described above, the propagation may be driven by a Laplace-Beltrami operator, which may be implemented by use of the adaptive finite element method and cotan Laplace formula. The underlying mesh of the OM modeling the ODS and the sound field data contained thereupon may evolve together cyclically in a tightly coupled feedback loop.

As the OM modeling the ODS evolves, not only may it absorb the incoming first rain attached to its surface, but it may also emit an outgoing second rain (i.e., a signal may be sampled from the OM modeling the ODS over a simplicial submanifold domain on the surface of the OM modeling the ODS). The second rain may form in the ambient space of the ODS as it evolves. The second rain formation sampling process may terminate after an interval of time. The second rain may then be emitted.

In step 914, the second rain may be mapped via a structure-preserving attaching map (e.g., a harmonic or conformal map) or via a composition of such maps to a second submanifold of a second OM modeling second a physical space triangulated from one or more actuators by a second CP. The result of this stage may be a second rain of PFM suspended over the second submanifold ready for actuation.

In optional step 916, the second rain may be optionally processed by application of a transformation. The transformation may be the identity, in which case the result of this stage may be to output the second rain unchanged. Other transformations mentioned above may also be used. In practice, it may be common to upsample the rain, in particular when after transformation it will ultimately be actuated by speakers or other actuators that may be operating and sampling at an extremely high rate appropriate to the fine-grained dynamics of sound in physical acoustic media. This step may also be used to filter out any noise that may be present in the signal.

In step 918, the second rain may be actuated in the second physical space by the one or more actuators.

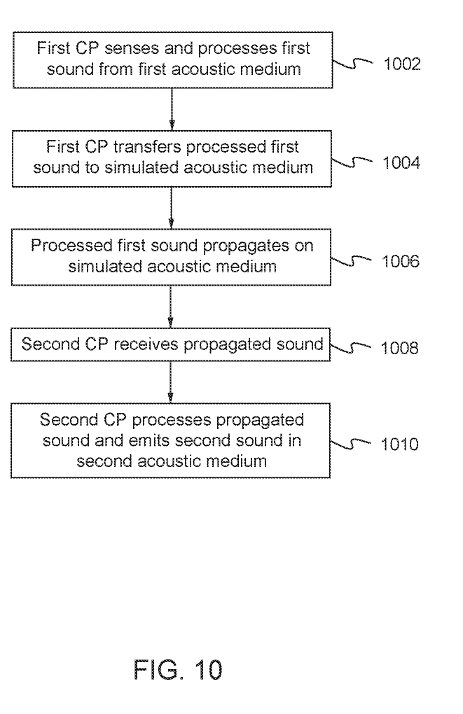

Referring now to FIG. 10, a high-level flow chart illustrating the synchronous distributed localization of sound in a cyber-physical system is shown. In step 1002, a first sound from a first acoustic medium may be sensed and processed by a first CP. In step 1004, the first CP transfer the processed first sound to a simulated acoustic medium. In step 1006, the processed first sound may propagate on the simulated acoustic medium. In step 1008, a second CP may receive the propagated sound. In step 1010, the second CP may process the propagated sound and emit it as a second sound in a second acoustic medium,

In another example, the first CP may impart the rain directly to the second CP controlling the one or more actuators for immediate absorption, using a structure preserving attachment map between the meshes modeling the first physical space and the second physical space. This may correspond, for example, to a scenario in which there is a point to point phone call, and there is no intervening cyber propagation process that takes place. In such a case, the sound field evolution captured by the one or more sensors and summarized by the first CP may be directly mapped to an actuation pattern produced at the output by one or more actuators.

Instead of a point to point connection, higher-dimensional spatial models of the input and output domains may be used. For example, the first CP may use a triangular set of sensors to capture a planar spatial sound field in the first physical space, form a rain that summarizes the evolution of sound over the triangulation of the first submanifold, and impart the rain to a triangular set of actuators, for sampling and absorption in the second physical space.

A series of physical domains may be chained together with network communication, attaching maps, and possibly filtering and sample rate conversions occurring between sampling and actuation events. For example, there may be a physical space in which an actuator is stationed at one location, and at some distance away in the space, a sensor is stationed at another location. The actuator (via a controlling CP) may receive an input in the form of a rain from some outside source. It may then actuate the received input, into the physical acoustic medium inhabiting the physical space, by absorbing the rain.

After some time, the sensor stationed some distance away in the same physical space may measure waves that were introduced into the space by the actuator, and which propagated, via the physical acoustic medium, through the space to the sensor. Any time delay and attenuation introduced via the propagation may correspond to coefficients of evolution and properties of the physical medium. This scenario of physical propagation may be very similar to the analogous cyber scenario, where a source of sound is received by a CP and imparted to an OM, the OM propagates the sound, and at some distance away from the source, at some later time, the propagated sound is sampled.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in any device or host computer.

What is claimed is:

1. A method for use in a computational platform (CP) for the distribution of sound in a cyber-physical system, the method comprising:
receiving one or more inputs from one or more sensors receiving a first sound in a first physical space;
constructing a mesh of a first oscillating manifold (OM) modeling the first physical space, the mesh comprising one or more points corresponding to the one or more sensors;
parameterizing the one or more inputs over the mesh to form a rain comprising a sequence of regular pulse fields; and
imparting the rain on a second OM modeling an open dynamical surface (ODS), such that one or more waves propagate on the second OM and are sampled by a second CP in order to generate a second sound in a second physical space using one or more actuators.

2. The method of claim 1, wherein the one or more points are based on a spatial relationship of the one or more sensors.

3. The method of claim 1, wherein the one or more inputs comprise scalar values.

4. The method of claim 1, further comprising processing the one or more inputs by application of a transformation.

5. The method of claim 1, wherein the parameterizing the one or more inputs over the one or more points comprises converting a value from the one or more sensors to a height of the one or more points in the mesh.

6. The method of claim 1, wherein the parameterizing the one or more inputs over the mesh is performed over a period of time.

7. The method of claim 1, wherein the second OM is modeled by a server.

8. The method of claim 1, wherein the second OM has one or more of topological features and boundaries that affect the propagation of the one or more waves and the second sound.

9. The method of claim 1, wherein the second OM comprises a patchwork composition of multiple OMs.

10. The method of claim 1, wherein the one or more sensors comprise transducers.

11. A computational platform (CP) for the distribution of sound in a cyber-physical system, the CP comprising:
a processor operatively coupled to one or more sensors receiving a first sound in a first physical space;
the processor configured to receive one or more inputs from the one or more sensors;
the processor further configured to construct a mesh of a first oscillating manifold (OM) modeling the first physical space, the mesh comprising one or more points corresponding to the one or more sensors;
the processor further configured to parameterize the one or more inputs over the mesh to form a rain comprising a sequence of regular pulse fields; and
the processor further configured to impart the rain on a second OM modeling an open dynamical surface (ODS), such that one or more waves propagate on the second OM and are sampled by as second CP in order to generate a second sound in a second physical space using one or more actuators.

12. The CP of claim 11, wherein the one or more points are based on a spatial relationship of the one or more sensors.

13. The CP of claim 11, wherein the one or more inputs comprise scalar values.

14. The CP of claim 11, wherein the processor is further configured to process the one or more inputs by application of a transformation.

15. The CP of claim 11, wherein the parameterizing the one or more inputs over the one or more points comprises converting a value from the one or more sensors to a height of the one or more points in the mesh.

16. The CP of claim 11, wherein the parameterizing the one or more inputs over the mesh is performed over a period of time.

17. The CP of claim 11, wherein the second OM is modeled by a server coupled to the CP over the communications interface.

18. The CP of claim 11, wherein the second OM has one or more of topological features and boundaries that affect the propagation of the one or more waves and the second sound.

19. The CP of claim 11, wherein the second OM comprises a patchwork composition of multiple OMs.

20. The CP of claim 11, wherein the one or more sensors comprise transducers.
